(19) United States
(12) Patent Application Publication
(10) Pub. No.: US 2011/0320191 A1
(43) Pub. Date: Dec. 29, 2011

(54) TEXT CREATION SYSTEM AND METHOD

(76) Inventor: Jean-Pierre Makeyev, Alameda, CA (US)

(21) Appl. No.: 13/255,891

(22) PCT Filed: Mar. 15, 2010
(86) PCT No.: PCT/US10/27333

§ 371 Date: Sep. 9, 2011

Related U.S. Application Data
(60) Provisional application No. 61/160,200, filed on Mar. 13, 2009.

(51) Int. Cl. G06F 17/27

(52) U.S. Cl. 704/9

(57) ABSTRACT

A text creation system and method is described. Input text is provided in an authoring language and may be provided in one or more rendering languages and/or writing styles. The input text is analyzed to determine the semantic content of the input, and the semantic information is stored in a database. In one embodiment, templates are provided to acquire input and information about the template and the semantic data of the input, along with a database of equivalent meanings in different languages, are utilized to instantly generate output in a number of languages. One embodiment is a method and system of presenting advertisements in multiple languages.

### CROSS-REFERENCE TO RELATED APPLICATIONS

This application claims the benefit of U.S. Provisional Application No. 61/160,200, filed Mar. 13, 2009, the entire contents of which is hereby incorporated by reference herein and made part of this specification.

### TECHNICAL FIELD

The present invention generally relates to the text generation, and more particularly to an apparatus and method for generating text in a plurality of languages or styles.

### BACKGROUND ART

The ability to communicate effectively is of great importance. Specifically, it is important that a writer's meaning be conveyed to a target audience in a meaningful and effective way. In general, the ability of electronic means to facilitate communication is limited. As one example, there exist a myriad of websites and newspapers that publish advertisements. These venues typically have a readership limited to specific geographical areas or interests. As a result, those wishing to search for advertised goods are limited in where and with whom they may acquire those goods.

In addition, advertisements are typically posted in one language, further limiting their readership. Since publications are typically published in only one language, users posting wishing to post in another language would have to translate their advertisements and find venues which publish in the other language.

Thus there is a need in the art for a method or apparatus to provide for a more accurate method and system for generating text in a target language. There is also a need in the art of advertisement for a method and system that permits the greater distribution and targeting of communication. The method or apparatus should permit a person to author text in their preferred language, and permit the publishing of the text in a number of languages.

It may also be difficult for an author to provide text in a style that is effective at reaching an intended audience, even in the authoring language. There is thus a need in the art for a method or apparatus to help authors target intended audiences according to writing styles.

The methods and apparatus should be easy to use for both the person authoring and for the person perusing the text. In one embodiment, the methods and apparatus should be easy for those providing text, and provide readable, detailed, and linguistically appealing text in other languages and/or writing styles.

### DISCLOSURE OF INVENTION

The present invention overcomes the disadvantages of the prior art by providing a method and system to provide equivalent text in a plurality of languages and/or writing styles.

In one embodiment, a method and/or system is provided to accept text in one language and provide an equivalent text in a plurality of other languages and/or writing styles.

In another embodiment, a method and/or system provides understandable text equivalents of an input, either in the author's language or in other languages.

In another embodiment, a method and/or system is provided to have access to a form to accept certain information. The information may be, for example and without limitation, information for an advertisement. The computer accepts input from the form and provides text of equivalent meaning in one or more other languages.

In yet another embodiment, a method and/or system is provided wherein text is provided using a semantics-based system, and where equivalent of words, phrases, or expressions that are provided based on their meanings.

In certain embodiments, a method and/or system is provided to create text from data supplied in a form.

In certain other embodiments, a method and/or system is provided to extract meaning from text, and to then create text with the same meaning in other languages and/or writing styles.

In yet certain other embodiments, a method and/or system is provided to create equivalent text according to a selected writing style.

In certain embodiments, a method and/or system is provided to allow a user to modify a created text by modifying semantic parameters. The modifications will affect the text in each other language.

In certain other embodiment, a method and/or system provides text in a plurality of languages. Thus, for example, a user is provided with a form for placing an advertisement. A system extracts the meaning of input to the form, and then provides advertisements having similar or identical meaning in one or more other languages. In one embodiment, the form is presented in an “authoring language,” while the information provided to the template is stored by the system in a predetermined, semantics-based, language-independent form. In another embodiment, the system includes one or more databases organized by semantics (the meanings of words) and language. The input in one language is stored as a language-independent index, facilitating a meaning-based generation of text. The system may also construct advertisements using the meanings of the input text and grammatical rules of an output language.

In yet another embodiment, a system provides website that allows users to place and read advertisements in a plurality of languages, where the generation of text in one or more of a plurality of languages is facilitated by a database of words stored according to their meaning.

In one embodiment, a method for operating a computer to generate text in a rendering language is provided. The method includes receiving one or more of a predefined number of inputs in an authoring language, where the inputs include words, phrases, sentences, numbers, or any combination thereof, and providing one or more grammatically correct sentences in the rendering language to convey the meaning the inputs.

In another embodiment, a computer readable medium on which are encoded one or more computer executable code segments that when executed by a processor cause carrying out of a method for operating a computer to generate text is provided. The method includes receiving one or more of a predefined number of inputs in an authoring language, where the inputs include words, phrases, sentences, numbers, or any combination thereof, and providing one or more grammatically correct sentences in the rendering language to convey the meaning the inputs.

In yet another embodiment, a method for operating a computer to provide an output in a rendering language is provided. The method includes retrieving, from computer readable memory, data related to one or more one or more words, phrases, or sentences, determining text in a rendering language corresponding to the data, and generating one or more grammatically correct sentences in the rendering language from the determined text.

In one embodiment, a computer readable medium on which are encoded one or more computer executable code segments that when executed by a processor cause carrying out of a method for operating a computer to provide an output in a rendering language is provided. The method includes retrieving, from computer readable memory, data related to one or more one or more words, phrases, or sentences, determining text in a rendering language corresponding to the data, and generating one or more grammatically correct sentences in the rendering language from the determined text.

In yet another embodiment, a method for operating a computer to provide text in one of a variety of writing styles is provided. The method includes accepting an input text, selecting a writing style from one of a plurality of writing styles, and generating one or more grammatically correct sentences according to the selected writing style, where the sentences convey the meaning of the input text. The method operates such that different sentences are generated depending on the selected writing style.

In one embodiment, a computer readable medium on which are encoded one or more computer executable code segments that when executed by a processor cause carrying out of a method for operating a computer to provide text in one of a variety of writing styles is provided. The method includes accepting an input text, selecting a writing style from one of a plurality of writing styles, and generating one or more grammatically correct sentences according to the selected writing style, where the sentences convey the meaning of the input text. The method operates such that different sentences are generated depending on the selected writing style.

In another embodiment, a semantic data structure stored in the memory of a computer, where the data structure organizes the meanings of one or more words in a plurality of languages, is provided. The data structure includes a plurality of unique semantic identifiers each corresponding to the same or similar meaning in each of the plurality of languages, and for at least one semantic identifier of the plurality of unique semantic identifiers, data representative of text having the meaning corresponding to the at least one semantic identifier in each language of the plurality of languages. The data structure is such that text corresponding to the at least one semantic identifier may be provided in any of the plurality of languages without specific reference to any of the plurality of languages.

These features together with the various ancillary provisions and features which will become apparent to those skilled in the art from the following detailed description, are attained by the method and system of the present invention, preferred embodiments thereof being shown with reference to the accompanying drawings and description, by way of example only, wherein:

### BRIEF DESCRIPTION OF DRAWINGS

FIG. 1 is a general flowchart of a method for text creation in one or more of a plurality of languages, or to a specific writing style;

FIG. 2 is a flowchart of an embodiment of a method for text creation in one or more of a plurality of languages, or to a specific writing style;

FIG. 3 is one embodiment of a system for performing one or more steps of a method of text creation;

FIG. 4A illustrates a first embodiment of the structure of a semantic data table;

FIG. 4B illustrates a second embodiment of the structure of a semantic data table;

FIG. 5 illustrates one embodiment of a semantic data table, which is a primary color semantic data table;

FIG. 6 illustrates another embodiment of a semantic data table;

FIG. 7 shows an input form in English to gather information for the posting of house information;

FIG. 8 shows the input form of FIG. 7 partially filed in;

FIG. 9 shows the input form of FIG. 7 filled in further;

FIG. 10 shows the input form of FIG. 7 in French;

FIG. 11 illustrates the structure of one embodiment of an input record database;

FIG. 12 illustrates the structure of an alternative embodiment input record database;

FIG. 13 is one embodiment of a query form;

FIG. 14 is an example of a semantic data table; and

FIG. 15 is one embodiment of a preview screen.

Reference symbols are used in the Figures to indicate certain components, aspects or features shown therein, with reference symbols common to more than one Figure indicating like components, aspects or features shown therein.

### MODE(S) FOR CARRYING OUT THE INVENTION

Although certain preferred embodiments and examples are disclosed below, it will be understood by those skilled in the art that the invention extends beyond the specifically disclosed embodiments to other alternative embodiments and/or uses of the invention and obvious modifications and equivalents thereof. Thus it is intended that the scope of the invention herein disclosed should not be limited by the particular disclosed embodiments described below. In any method or process disclosed herein, the acts or operations making up the method/process may be performed in any suitable sequence, and are not necessarily limited to any particular disclosed sequence. For purposes of contrasting various embodiments with the prior art, certain aspects and advantages of these embodiments are described where appropriate herein. Of course, it is to be understood that not necessarily all such aspects or advantages may be achieved in accordance with any particular embodiment. Thus, for example, it should be recognized that the various embodiments may be carried out in a manner that achieves or optimizes one advantage or group of advantages as taught herein without necessarily achieving other aspects or advantages as may be taught or suggested herein.

Text creation systems and methods as described herein may be used for a variety of purposes. In certain embodiments, the system or method operates on certain, predetermined data, such as inputs to a form, and the output is produced in a more natural language text, such as in print, on a screen of an electronic device, or in a voice-generated output of a computer. Examples of such purposes include, but are not limited to, the generation of advertisements, manuals for products, letters, insurance quotes, itineraries, or customer support troubleshooting documents. Examples are presented herein where text creation systems and methods are used to generate advertisements on an electronic display. In such examples, the input provided are attributes of items to be advertised. It is to be understood that reference to input as “attributes” or of providing advertisements are presented herein merely for illustrative purposes of describing one use of the method or system, and is not meant to limit the scope of the invention, except as explicitly limited in the Claims.

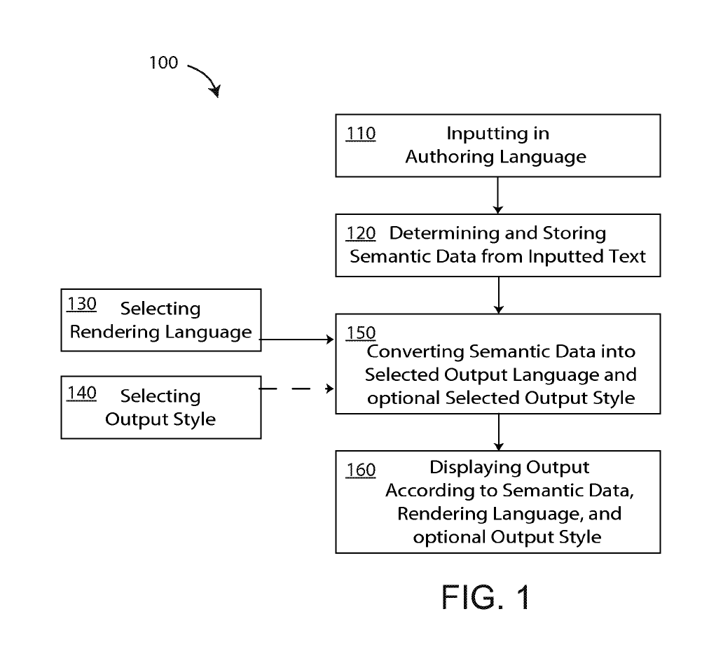

FIG. 1 is a general flowchart of a method 100 for text creation in one or more of a plurality of languages, or to a specific writing style. As shown in FIG. 1, method 100 may include, for example and without limitation, the steps labeled as: Inputting in Authoring Language in Block 110; Determining and Storing Semantic Data from Inputted Text in Block 120; Selecting Rendering Language in Block 130; and optional Selecting Output Style in Block 140; Converting Semantic Data into Selected Output Language and optional Selected Output Style in Block 150; and Displaying Output According to Semantic Data, Rendering Language, and optional Output Style in Block 160.

In Block 110 (Inputting in Authoring Language), a user provides input in an authoring language. The input may, for example, be provided as free-form text, or according to a form with that provides pre-determined input selections. In one embodiment, the input is provided as input text, such as words, phrases, sentences, or as numerical input.

In one embodiment, method 100 may operate in one or more “system languages” System languages may include, but are not limited to, English, Spanish, Chinese, Japanese, Korean, French, Italian, Portuguese, German, Arabic, Urdu, Farsi, Dutch, Swedish, Norse, Danish, Finnish, Russian, Polish, Serbian, Romanian, and/or Tagalog. In one embodiment, system languages are selected from among those available on electronic devices.

In general, text creation and the application of writing styles is facilitated by storing words, phases, or sentences in each of the system languages according to their meaning (semantics). One such way of organizing such information, which is not meant to limit the scope of the present invention, is in a “semantic data table.” The term “semantic data table” is used herein without limitation, to include one or more tables, databases, or other structure of semantic datum each having a unique semantic identification (“semantic ID”) corresponding to a meaning. In one embodiment, each semantic ID has an association to a word, phrase, or sentence in each of the system language having the same or nearly similar. The semantic ID may be, for example and without limitation, a number, a string of characters or symbols, or some combination thereof. The semantic data table includes, for each semantic ID, text (words, phrases, or sentences) in each of the system language representing the same “meaning” as indicated by the semantic ID.

Semantic data tables may thus be constructed to organize different languages according to meanings. With words, phrase, or sentences so organized, the system or method may easily and rapidly provide text of equivalent meaning one or more languages. When an attribute is chosen in an authoring language, the corresponding semantic ID is thus known by prior association. Further, the same meaning may be represented in any other system language using the same semantic data table.

In another embodiment, semantic data tables may include an indication of the relationship between different semantic IDs. Thus, for example and without limitation, a semantic ID entry may be associated with one or more other semantic IDs, thus providing a linkage between semantic IDs. Thus, for example, there may be a semantic ID for “color” and semantic IDs for each color. As described above, the semantic data table includes entries for “color” and entries for each color, along with text in each of the system languages. In one embodiment, a semantic ID association may link the semantic IDs together. In one embodiment, a “color” semantic ID table includes a list of semantic IDs for all of the other colors. Alternatively, the semantic data table may include columns for listing associated semantic IDs. In this example, the semantic ID entry for each color could include an association column in which is stored the semantic ID for “color.” This linking may extend several levels, associating deeper meanings or more detailed amount of meaning.

In Block 120 (Determining and Storing Semantic Data from Inputted Text), the semantic meaning is extracted from the inputted text in the authoring language in accordance with the semantic data table, and the semantic information is stored. The stored semantic information associated with an input is referred to herein, without limitation, as an “input record.” Thus, for example, the semantic ID corresponding to the word, phrase or sentence in the authoring language is extracted and stored.

In Block 130 (Selecting Rendering Language) an output, or rendering, language is selected from among the system languages. The rendering language may be the same as, or may be different from, the authoring language.

In Block 140 (Selecting Output Style) an optional output style is selected, either by a user, or randomly by the method. The style refers to the writing style of the output text. Thus, for example one may convey essentially the same information by writing short, concise sentence (“terse”), or by forming more complex sentence structures, such as or “emphatic,” or by using more “flowery” language. These may be specified according to a list of pre-defined styles.

In Block 150 (Converting Semantic Data into Selected Output Language and optional Selected Output Style), the stored semantic data is assembled into the language selected in Block 130 and according to the optional style selected in Block 140. Specifically, as noted previously, method 100 has access to semantic data tables including equivalent text strings in each of the system languages. Thus the semantically equivalent text in the rendering language may be determined from the semantic data table.

In addition, Method 100 also has access to syntax and grammar rules for assembling sentence from words or phrases in each system language. In Block 150 the rules of syntax and grammar may be applied to the text to form correct sentences in the rendering language. In some embodiments, only very syntactic structures, such as word order, are respected. Similarly, only simple grammatical rules, such as gender and number agreements, are respected. In more sophisticated or more semantically demanding applications, more complex syntactic structures and more numerous grammatical rules. Further, the rules may also be applied to vary the complexity of the sentence structure, for example, according to the optional selected writing style.

In Block 160 (Displaying Output According to Semantic Data, Rendering Language, and optional Output Style), the output of Block 150 is provided to the user. The output, for example and without limitation, may be provided over an Internet connection to an electronic device and rendered as text or as a voice on a speaker.

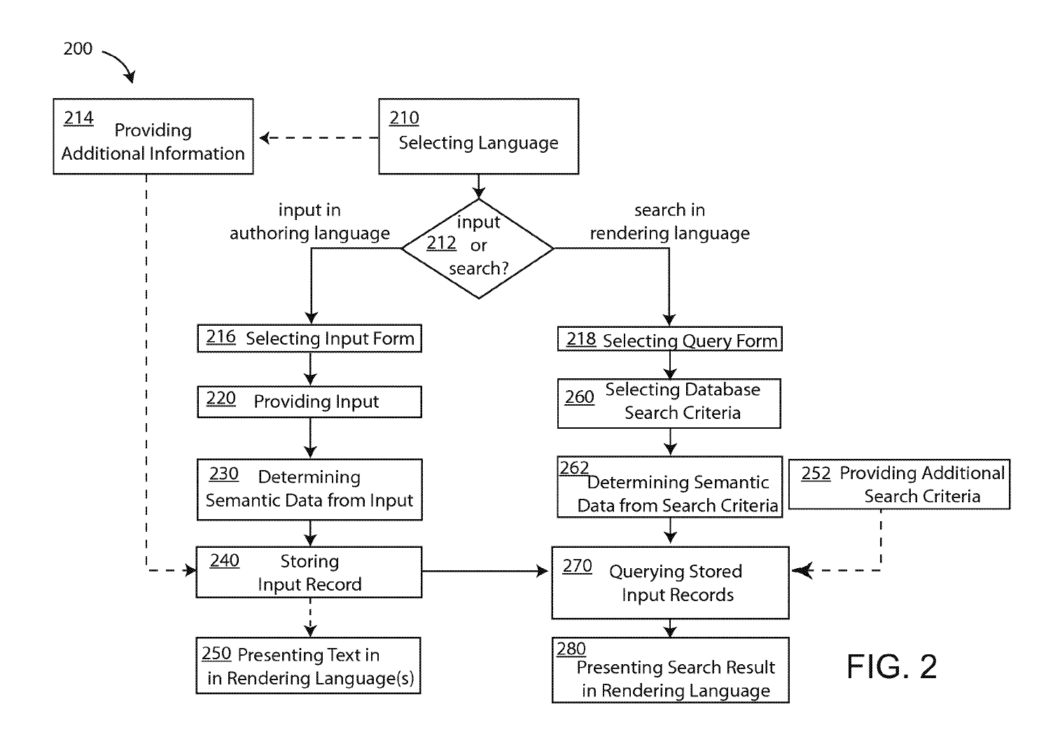

FIG. 2 is a flowchart of an embodiment of a method 200 for text creation in a plurality of languages, or to a specific writing style. Method 200 may be generally similar to the embodiment of method 100, except as further detailed below. Where possible, similar elements are identified with identical reference numerals in the depiction of the embodiments of FIGS. 1 and 2.

Specific embodiments are presented herein where method 200 allows for accepting, storing, providing and/or searching of information related to classified advertisements, such as for items or jobs. It is to be understood that these embodiments are provide for illustrative purposes, and are not meant to limit the scope of the present invention.

As shown in FIG. 2, method 200 may include, for example and without limitation, the steps of: Selecting Language in Block 210; selecting between Input or Search in Block 212; Selecting an Input Form in Block 216; Providing Input in Block 220; Determining Semantic Data from Input in Block 230; Storing Input Records in Block 240; selecting Query Form in Block 218; Selecting Database Search Criteria in Block 260; Determining Semantic Data from Search Criteria in Block 262, Query Stored Input Records in Block 270; and Presenting Search Result in Rendering Language in Block 280. Additional alternative steps are shown in FIG. 2 as Providing Additional Information in Block 214; Presenting Text in Rendering Language(s) in Block 250; and Providing Additional Search Criteria in Block 252.

In Block 210 (Selecting Language) a user selects one of the system languages, which is then referred to herein as the “selected language.” The selected language is used for interacting with or providing information from method 200. The selected language may also be used, for example and without limitation, as an authoring language to prompt the user for input text, or as a rendering language to generate output text. In an alternative embodiment, there is only on system language, and Block 210 may not be provided to method 200.

Alternatively, in Block 214 (Providing Additional Information), the user may also provide additional information in the authoring language. Specifically, the user may provide additional information which may be specific to the user, which may include but is not limited to, information used to authenticate a user on a system, to permit a user to register for use of the method 200, or to accept information that may be used elsewhere by the method, such as a preferred output writing style, (as for example, in Block 140) or as a user's country.

In another embodiment, the additional information from Block 214 is used in Block 270 (Querying Stored Data) to limit or control search results.

In Block 212 (Input or Search?), the user is prompted, in the selected language, to indicate if they wish to provide new information or find previously stored information. At this point the selected language is also referred to as: the authoring language of Blocks 214, 216, and 220; or the rendering language of Blocks 218, 250, 252, 260, 250 and 280.

In one embodiment, Block 216 (Selecting Input Form) may provide the user with the selection of one or more forms or questionnaires (referred to in general, as a “form”), resulting in a “selected form.” In general, method 200 accepts and provides information related to specific types of data or information. In certain embodiments, the forms are directed to classifying information according to attributes of an item, person, or place, and the form prompts a user to provide certain attributes that describe the item, person, or place.

In Block 220 (Providing Input), the user provides input as prompted by the selected form. Thus, for example and without limitation, the selected form may provide attributes, which may be selected from attribute fields. In certain embodiments, a selected form is available in each system language.

In general, an attribute may include, but is not limited to, a word, phrase, sentence, or number that is descriptive of an object (a color is an attribute of an object), or can be another object (a swimming pool could be an attribute of a house). In certain other embodiments, the form has one or more “attribute fields” that each present a plurality of attributes for selection. Thus, for example and without limitation, an attribute field may present a predetermined number of attributes in a system language—thus a color attribute field may present a pre-determined list of colors in a selected language. In certain other embodiments, an attribute field accepts user input, such as a number attribute.

As a specific, illustrative example, separate forms may be provided for gathering information on automobiles, homes, or jobs. Thus, for example and without limitation, the attributes may be the make, model, mileage of a car; location number of room, style, or price of a house, or details of requirements for a job. Each form may then provide prompts for providing one or more attributes related to the item of interest. In addition, attributes may provide multiple levels of details. It is to be understood that the terms “form,” “item,” and “attribute” are illustrative and are not meant to limit the scope of methods 100 or 200.

In certain embodiments, method 200 includes different forms for gathering different types of information, as discussed subsequently. In an alternative embodiment, there is only one form associated with method 200, and Block 216 is not present in the method.

In Block 230 (Determining Semantic Input Records from Input), the semantic data of the input provided in Block 220 is extracted according to a predetermined association in a semantic data table.

In general, the steps of Blocks 216, 220 and 230 work in concert to accept attributes in the authoring language and determine their semantic meaning. Thus, for example and without limitation, the input form and selected in Block 216 is presented along with attribute fields in the authoring language in Block 220. Block 230 determines the meaning of each attribute according to the semantic ID of the selected attribute and the structure of the selected form.

In Block 240, the semantic data determined in Block 230 is stored as an “input record.” Importantly, Block 240 stores semantic data, for example and without limitation, as the semantic ID corresponding to the attributes selected in the attribute field of the form, and does not store the input provided in the selected language. Thus, for example, the input record includes the semantic IDs corresponding to each of the attribute field. In general, the full meaning may be extracted from the semantic IDs and the context of the attribute fields within the form.

In certain embodiments, each input record is provided with a unique input record identification number. In certain other embodiments, the input record includes information provided in Block 214. In one embodiment, input records are is stored in one or more tables or databases. In another embodiment, input records are stored in a table or database corresponding to the form used to generate the semantic data, facilitating later searching of the input records.

Additionally, the step of Storing Data (Block 240) may also associate other information with the semantic data for a specific input, such as the input of Block 214. Thus, for example and without limitation, the input record includes data that is retained in the authoring language, which may include but is not limited to some or all of: a preferred output writing style (from Block 214), an author's identity or contact information, or the time, date, location, or authoring language of the provided input (from Block 210).

Further, the step of Storing Data (Block 240) may also include searching information as provided in Block 214 within the input record. Thus, for example, a user providing input may wish to have information available only to speakers of certain languages or within certain geographical areas. The input may be, for example, provided to a posting on a dating website, where the user wishes to restrict respondents to those living within a certain area, or who can speak certain languages. For these embodiments, the input record may also include limitations on the search capabilities as discussed subsequently.

It is understood that other, non-semantic information may also be stored in the semantic input record database, but that at least some of the information includes semantic IDs.

Blocks 216, 220, 230, and 240 roughly correspond to Block 120 of FIG. 1.

In an alternative embodiment, the input from Block 220 is converted to a plurality of rendering languages and is presented (as in Block 250). Thus, for example, an advertisement provided in Block 220 is simultaneously published for viewing in one or more rendering languages by other users. The conversion of semantic data into rendering language text is described subsequently with reference to Block 280.

In one embodiment, method 200 allows for one or more inputs to be entered by one or more users. Thus, for example and without limitation, method 200 may be used to store a plurality of different inputs, such as different classified advertisements. Block 240 may provide for each input record to be stored, for example and without limitation, as a group of related data in a relational database.

Returning to Block 212, if the user selects “search” in the step of Block 212, the steps of Blocks 218, 260, 262, 270, and 280 provide a method for a user to search the data stored in the step of Block 240. The user that is searching may be the same or different from the user that provided input in the Blocks 220.

In Block 218 (Selecting Query Form), a user selects one of one or more query forms in the rendering language for searching. In general, the forms of Block 218 correspond to the forms of Block 216. Thus one may select, for example, to search for specific types of data or information, as discussed above regarding Block 216. For the illustrative example of advertisements, a user may select a form for searching for an automobile, homes, or a job. The query form selected in Block 218 may have attribute fields that correspond to some or all of the attribute fields of the corresponding input form of Block 216, or may have different attribute fields.

In Block 260 (Selecting Database Search Criteria), input is provided as prompted by the selected query form. Thus, for example and without limitation, the selected form may provide attributes which may be selected from attribute fields. In certain embodiments, a query form is available in each of the system languages.

In Block 262 (Determining Semantic from Search Criteria), the semantic data of the query provided in Block 260 is extracted. As discussed above with reference to Block 230, extraction is facilitated by establishing, in each system language, a semantic equivalence for each attribute according to the semantic data tables.

In Block 270 (Querying Stored Data using Selected Criteria Semantic Data), the semantic data of the search criteria are used to search the semantic data stored in Block 240. In one example, the stored semantic data is in the form of a relational database, and the search takes the form of a database search query. Such a search may return no matches or one or more matches.

In alternative embodiments, the query of Block 270 may be restricted according to the authoring user's input in Block 214 or by additional search criteria in Block 252. Thus, for example, the search of Block 270 may be restricted by the author of individual input records according to input provided in Block 214. Thus even though the input fulfills the searchers criteria, the author may want to limit readers to a certain geographical area user the search may be further limited according to instructions provided by the user providing the original text.

As another example of a restriction to a search, additional search restrictions may be placed in Block 252. Thus, for example, input records may be restricted by the date that they were entered. As another example, the search criteria of Block 260 may be overridden to provide a greater range out matching input records or to ignore certain search criteria.

In Block 280 (Presenting Search Result in Rendering Language) and Block 250 semantic data is presented in a rendering language. As noted above in the discussion of Block 230, method 200 includes a semantic equivalence for each attribute in each of the system languages. Converting the stored semantic data requires determining the conversion into the rendering language. For the example of a semantic data table having a unique semantic ID number assigned to an attribute in each system language, the conversion is accomplished by determining the text in the rendering language having the corresponding semantic data. Thus, for example, if a table has a semantic ID as a first column, and each subsequent column having attributes in one of the system languages, then the conversion is accomplished by reading across from the semantic ID to the rendering language.

Blocks 250 and 280 may further include applying grammar, syntax, and semantic rules to the rendering language text strings to arrange the text and present the information contained therein in the rendering language. Thus, for example, each language has rules regarding tense and gender which must be applied to produce readable text in the rendering language. In certain embodiments, knowledge of the query and/or search form is embedded in generating the output. For example, if one is searching a housing database, and the attribute “yellow” is stored for a query for the house color, then grammar, syntax, and semantics rules may be applied to generate text reporting “The house is yellow” in any of the system languages.

In one embodiment, Blocks 250 or 280 may randomly decide between several equivalence texts in the rendering language. Thus, for example, the equivalence may be provided at different levels of linguistic complexity, or writing styles.

Blocks 250 and 280 roughly correspond to Block 150 of FIG. 1.

Additional features of method 200 include, but are not limited to, permitting buyers and sellers to negotiate a price back and forth, each in their own language, providing shipping services and providing for payment guarantee services that will ask banking information.

In other alternative embodiments, one or more of the steps indicated for methods 200 in the blocks of FIG. 2 maybe combined, or the functions may be shared by the steps of other blocks.

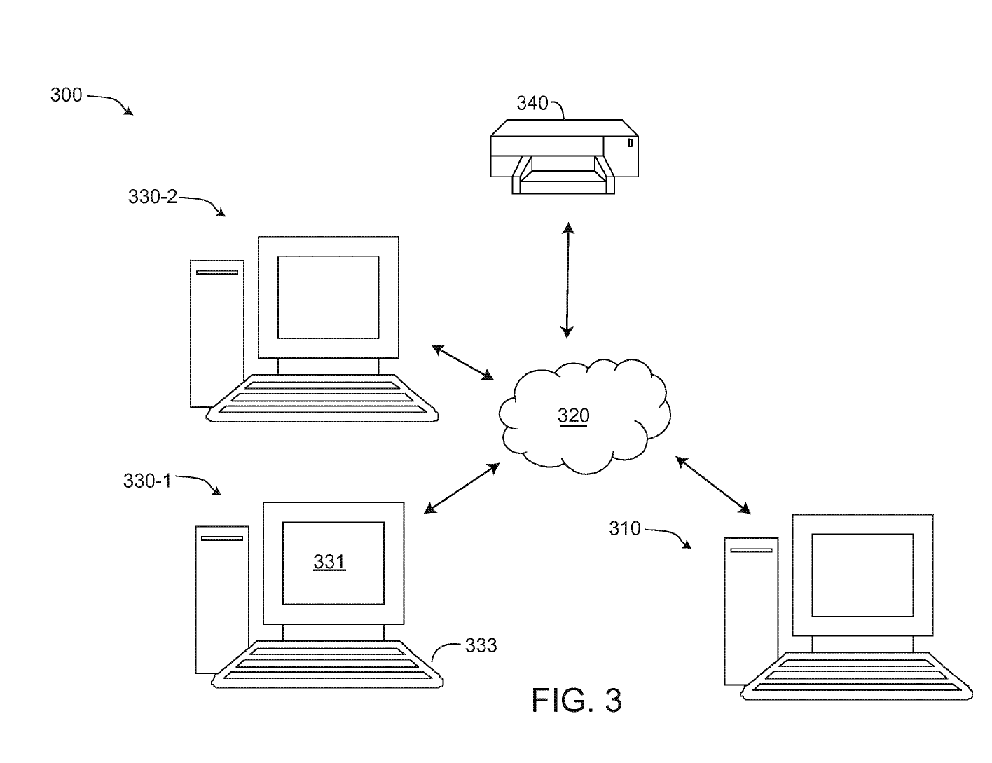

FIG. 3 illustrates several embodiments of a system 300 for performing one or more steps of a method of text creation, including but not limited to method 100 or 200. In one embodiment, system 300 includes an electronic device 310 programmed to provide method 100 or 200. In another embodiment, system 300 includes electronic device 310 which is a server, and which is connected over a network 320 to one or more device 330 (shown, for illustrative purposes, as devices 330-1 and 330-2). Devices 310 and/or 320 include processors and/or memory, may have input and output devices, and may include one or more devices networked together. Device 330 may be a conventional computer, such as desktop or laptop computers, or may be cell phones, personal digital assistants (PDAs), or any other device capable of providing input into device 310. Device 330, in general, includes a display 331 and input device 333. Display 331 may be, for example and without limitation, a computer monitor or the display of a cell phone. Input device 333 may be, for example and without limitation, a computer keyboard, a mouse or other pointing device, or a cell phone keypad. A printer 340 may also provide an out put in accordance with methods 100 or 200.

Thus, for example and without limitation, device 310 may provide web pages and accept input in accordance with methods 100 or 200 from device 320. Thus, for example, communications with user may occur on device 330, which communicates, over network 320, to a device 310 that includes the programming of the method. Alternative, an additional networked computer 310 may include memory for storing databases. The semantic data tables and semantic input record database are stored in system 300, and may, for example reside in the memory of device 310.

In one embodiment, system 300 may first provide a log in screen to display 331, requiring user information and possibly requiring payment from the user to use the system. The steps of method 100 or 200 may be performed by device 310 providing web pages to device 330, with the user input to the web pages providing the commands required by the method. In one system, information is exchanged between devices 310 and 230 via web pages, which may be, for example and without limitation, in a markup language such as a hypertext markup language (HTML) or extensible markup language (XML). Other programming, such as database searches and the programming required to generate web pages, are provided on device 310.

In another embodiment, device 310 includes a relational database comprising semantic data tables with semantic IDs and corresponding text strings in each of the system languages (such as table 400, as described subsequently). Input and query forms (such as forms 700 or 1300, respectively, as described subsequently) are provided from device 310 to device 330 as web pages in a markup language in each of the system languages. The web pages display one or more attributes in the system language and also contain, but do not display, the associated semantic ID. When device 330 users selects attributes, the associated selected semantic IDs are transmitted to device 310. The selected semantic IDs from input form are then sorted as input records in one or more input record relational databases (such as database 1100 or 1200, as described subsequently) in device 310. The selected semantic IDs from query forms are used to formulate structured query language (SQL) database queries to the input record databases. The generation of text occurs by first converting the stored semantic IDs for an input record into rendering language text by querying the semantic data tables with the semantic IDs to return the appropriate text in the rendering language, and then applying grammar rules, and syntax rules and one or more style rules of the rendering language by manipulating the returned text. The application of grammar, syntax, and/or style rules occurs within device 310 by programming the device to accept text in a rendering language and possibly semantic IDs, and manipulate the text according to one or more predetermined rules of the rendering language to provide grammatically correct sentences in the rendering language. The sentences may then be incorporated into a markup language and be provided to device 330 on a web page.

The methods of the text creation, including but not limited to any or all of methods 100 or 200, may be programmed and operate on system 300 in nearly any operating system and using programming languages which may include, but are not limited to, C, C++, C#, JAVA, PHP, Perl, Visual basic, Python, Javascript, Shell, Ruby, or Delphi.

### Semantic Data Tables

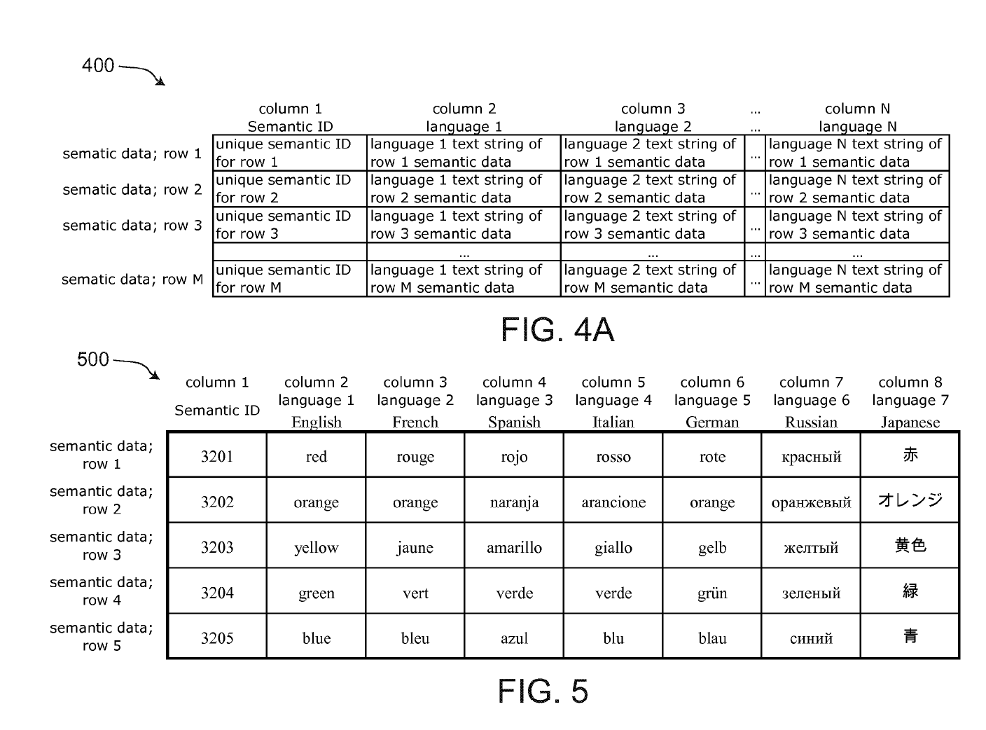

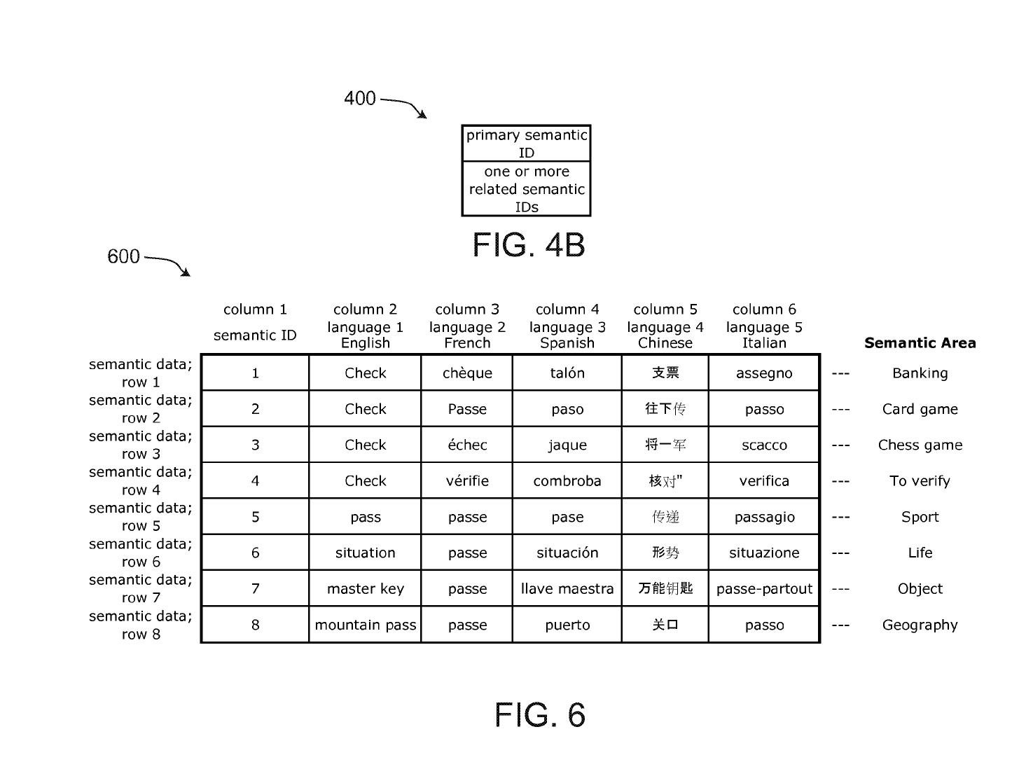

In one embodiment, one or more tables of semantic data are provided as part of method 100 or 200 and/or system 300. FIG. 4A illustrates a first embodiment of the structure of a semantic data table 400. Each row of the table has a different semantic meaning. The first column of the table is a semantic ID, and the remaining columns include one column for each of the system languages. For each language, the table holds or refers to a text string (or “text”) in that language corresponding to the semantic meaning of the row.

FIG. 4B illustrates a second embodiment of the structure of semantic data table 400. Semantic data table 400 of FIG. 4B lists semantic IDs of related meanings and includes, for example, a primary semantic ID and one or more subordinate, more primary, or otherwise related semantic IDs. Thus, for example, the primary semantic ID may be the semantic ID for “color” and the related semantic IDs are the semantic IDs for each of a plurality of colors. Alternatively, the primary-related semantic ID linking information may be provided as additional columns in a table similar to table 400 of FIG. 4A. Thus, for example and without limitation, the semantic data table may include columns having the text in the system language, as in FIG. 4A, and one or more additional columns having related semantic IDs, such as one or more primary or related semantic IDs.

The combination of the tables 400 of FIGS. 4A and 4B allow system 300 to determine the text in the various system languages having similar meaning for each language

Semantic data tables 400 of FIGS. 4A and/or 4B may be provided before executing method 100 or 200, for example, by people knowledgeable in the system languages compiling like-meaning words, phrases, or sentences, and assigning the same semantic ID to each and/or relating different semantic IDs.

In one embodiment, there is one semantic data table. Alternatively there may be a plurality of semantic data tables. Thus for example, the semantic data tables may be classified according to general meaning, and there may be one semantic color table for primary colors, one semantic data table for words related to job descriptions, etc.

FIG. 5 illustrates one embodiment of a semantic data table, which is a primary color semantic data table 500 which may be part of table 400. The entries in table 500 are all closely associated semantically, in that they are a semantic data sub-table of primary colors. Each row in table 500 includes a semantic ID for each primary color in column 2, and the text string (or simply “text”) associated with primary colors for each system language in the other columns. In one embodiment, the table entries in the semantic ID field are numbers, and the text entries in the various languages are the text strings for the color in those languages. The semantic ID “3201,” for example, corresponds to the English language text “red,” the French language text “rouge,” the Spanish language text “rojo,” and other text strings in the other listed languages. The number “3201” can be considered the semantic identity ID number of the primary color red, and the text for a specific language is easily accessible.

As an example, when a user of system 300 selects English as the language, then selects or types the text “red,” the system stores the input as the number “3201.” When method 200 is to provide text in the rendering language, the semantically equivalent text string for the number “3201” is found from the column of the rendering language. Thus the input primary color having a text string “red” in English is instantly converted into the text string “rouge” when the rendering language French is selected.

In an alternative embodiment, table 500 includes an additional column listing the primary semantic ID corresponding to “primary color.” Thus a search for the semantic ID of “primary color” identifies the semantic IDs of each primary color.

Since it is common for some words may have more than one meaning, (“homographs”) it is important that semantic data table 400 be able to account for these meanings. Specifically, by providing one row for each meaning, creating of text in any of a plurality of languages is occurs without a loss of meaning. FIG. 6 illustrates another embodiment of a semantic data table 600, which may be part of table 400. Also shown on the right side of FIG. 6 are the semantic areas of the rows, providing an explanation of how or where the words of the row are used. Each row has a different semantic ID in column 1. To illustrate homographs, table 600 includes: four homographs of the English word having the text “check” in column 2—the meaning in row 1 is from banking, the meaning in row 2 is from card games, the meaning in row 3 is from chess, and the meaning in row 4 refers to verify; four homographs of the French word indicated by the text string “passo” in column 3—the meaning in row 5 is used in sports, the meaning in row 6 is used in life (equivalent to the text “situation” in English), the meaning in row 7 is an object, and the meaning in row 8 is used in geography; and two homographs of the Italian word having the text string “passo” in column 6—as used in a card game in row 2 and as used in geography in row 8.

The importance of retaining the meaning of words in apparent from the entries in table 600. The text “check” in English is converted differently in various languages depending on the meaning of the word. English has one word with four meanings, whereas the other languages have a different word for different meanings. Going back and forth between languages is problematic—without reference to the semantic ID, one could translate the text “check” in English into the text “passo” in Italian, and then later translate it to the text “mountain pass” in English, which has a definition very different from the original English text “check.” It will be appreciated that by storing semantic IDs, text may be rendered in a plurality of languages without out loss of meaning. Also, storing semantic IDs instead of language text, generation of text in any one of the system languages facilitated.

In one embodiment, each attribute field may have its own semantic data table or tables. These semantic data tables, however, may be amended and used in other categories and subcategories of semantic areas. Some semantic data tables may be generic (i.e., colors) and may be used for other attribute fields.

As another representation of the semantic data table is as follows. Let i be an index for the semantic data entry (the “row” in semantic data table 400) and let l be an index for one of L system languages (for example, l=1 for English, l=2 for Spanish, etc. to l=L for the number of system languages). The table may written in functional form as having, for each semantic data entry i, a semantic identification number of ID(i) and a text stream in a language l of A(ID(i),l). Selection of a text stream having a meaning of semantic data table entry i in a language l* is thus A(ID(i),l*). The equivalent text stream in a different language l** is thus A(ID(i),l**).

### Input Forms

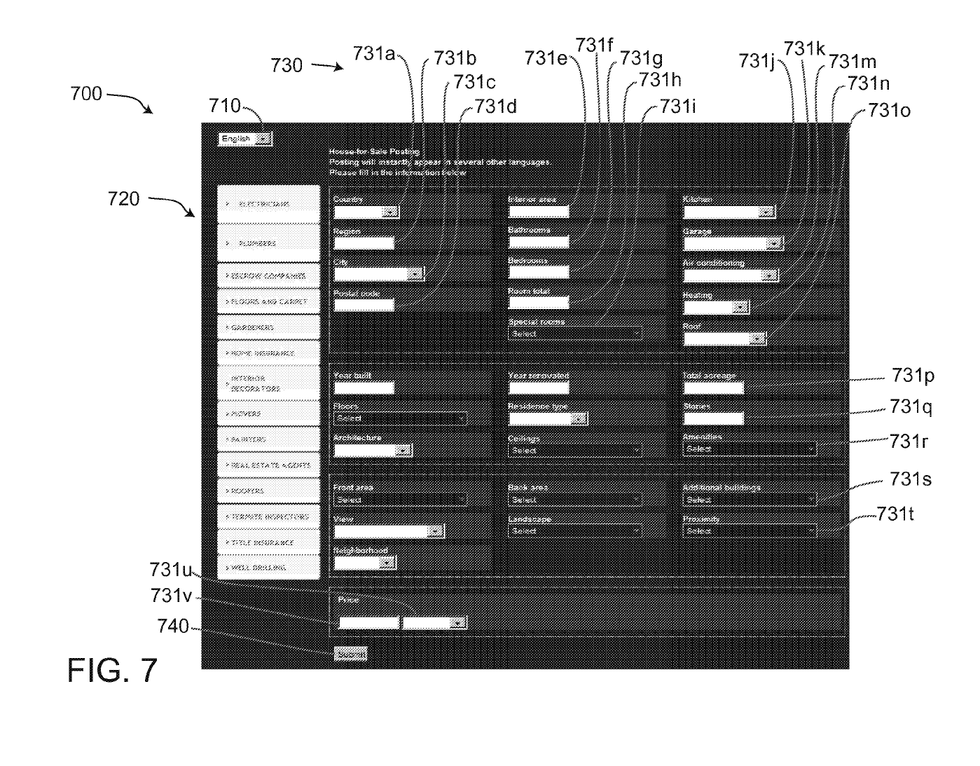

In certain embodiments, input forms are provided in an authoring language, which may be any of the system languages. As an example, FIG. 7 shows an input form 700 to gather information for the posting of house information. Input form 700, for example and without limitation, may be provided on display 331. Input form 700 has pull-down authoring language menu 710, which lists each system language, and from which “English” as selected. The language of screen 700 is governed by the language selected in menu 710, and thus all of the text displayed in screen 700 is in English.

Screen 700 has links 720 to advertisements, a plurality of input fields 730, and a “Submit” button 740. Input fields 730 include, for example and without limitation, fields 731 (several of which are labeled 731a-731v). There can be any number of attribute fields required to convey the required information. Thus, for example and without limitation, the attribute fields include, in English, the following text strings as shown in quotes: “Country” (field 731a), “Region” (field 731b), “City” (field 731c), “Postal code” (field 731d), “Interior Area” (field 731e), “Bathrooms” (field 731f), “Bedrooms” (field 731g), “Room Total” (field 731h), “Special Rooms” (field 731i), “Kitchen” (field 731j), “Garage” (field 731k), “Air Conditioning” (field 731m), “Heating” (field 731n), “Roof” (field 731o), “Total acreage” (field 731p), “Stories” (field 731q), “Amenities” (field 731r), “Additional Buildings” (field 731s), “Proximity” (field 731t), and “Price” (fields 731u and 731v). Other attributes include “Year built,” “Year renovated,” “Floors,” “Residence Type,” “Architecture,” “Ceilings,” “Front Area,” “Back area,” “View,” “Landscape,” and “Neighborhood.”

In one embodiment, fields 730 are limited to accept either specific inputs, or numerical inputs, which may be of certain numbers, arbitrary numbers, or within specified ranges of numbers. Fields 731 are attribute fields and include, but are not limited to pull down menus (for example, fields 731a, 731c, 731j-731o, and 731u), numeric input (for example, fields 731b, 731d-731h, 731p, 731q, and 731v), and check boxes (for example, fields 731i, and 731r-731t).

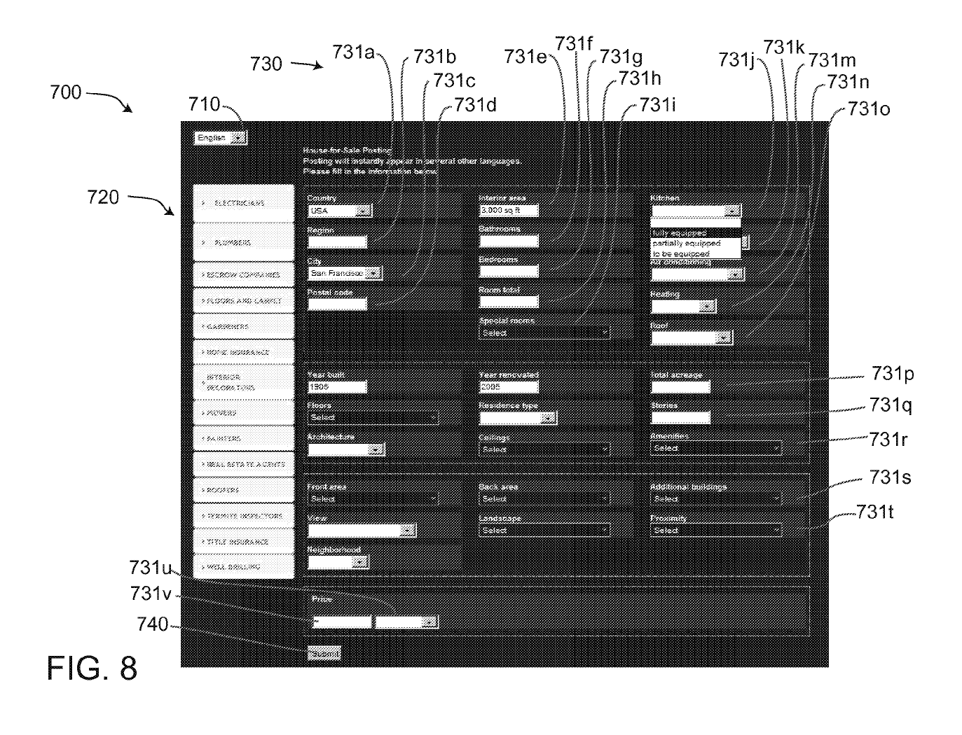

FIG. 8 shows input form 700 partially filled in. Importantly, the pull-down menus provide appropriate descriptive attributes. Thus, field 731a has “USA” selected from a plurality of county options from a pull-down menu, and field 731c has “San Francisco” selected from a plurality of city options, where the city options conform with cities corresponding to the USA country selection. If a different country had been selected in field 731a, then different cities would be provided for choices in field 731c. Several of the numeric input fields have been provided. Some fields are left blank. Field 731j is shown listing several options for the “Kitchen” attribute.

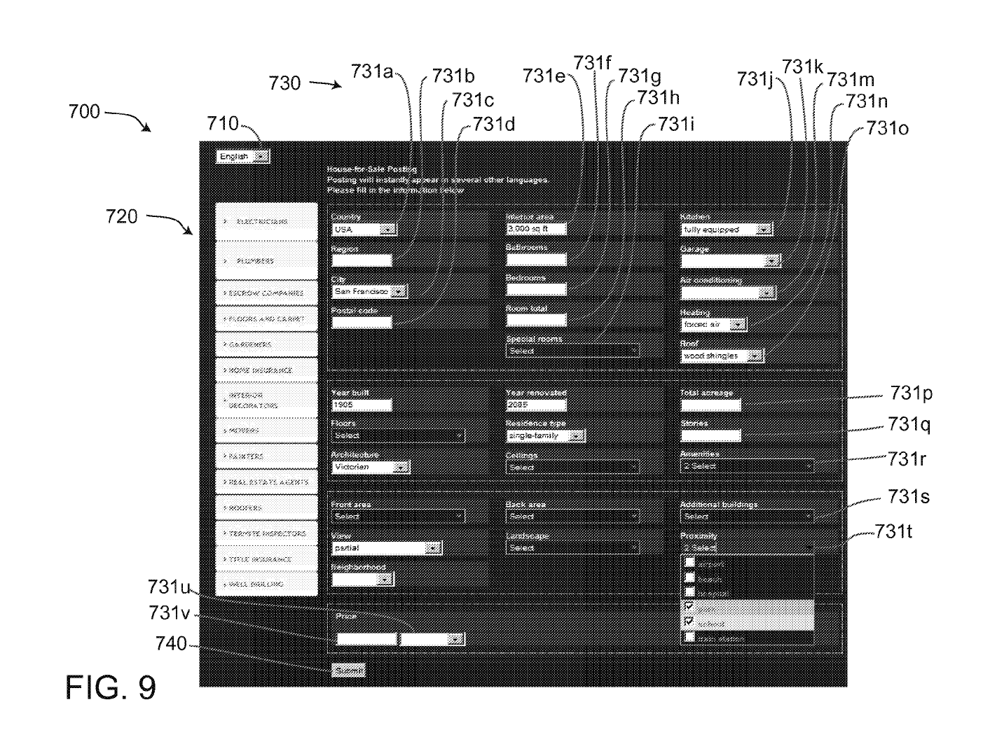

FIG. 9 shows input form 700 further partially filled in. FIG. 9 illustrates several proximity selections checked in field 731t, indicating that the house is near a park and a school.

When a user has provided as much information to input form 700 as they wish, they may click on the “Submit” button 740. The language selected in menu 710 and the attributes provided in fields 730 are then stored. Thus, for example and without limitation, the information is provided to device 310.

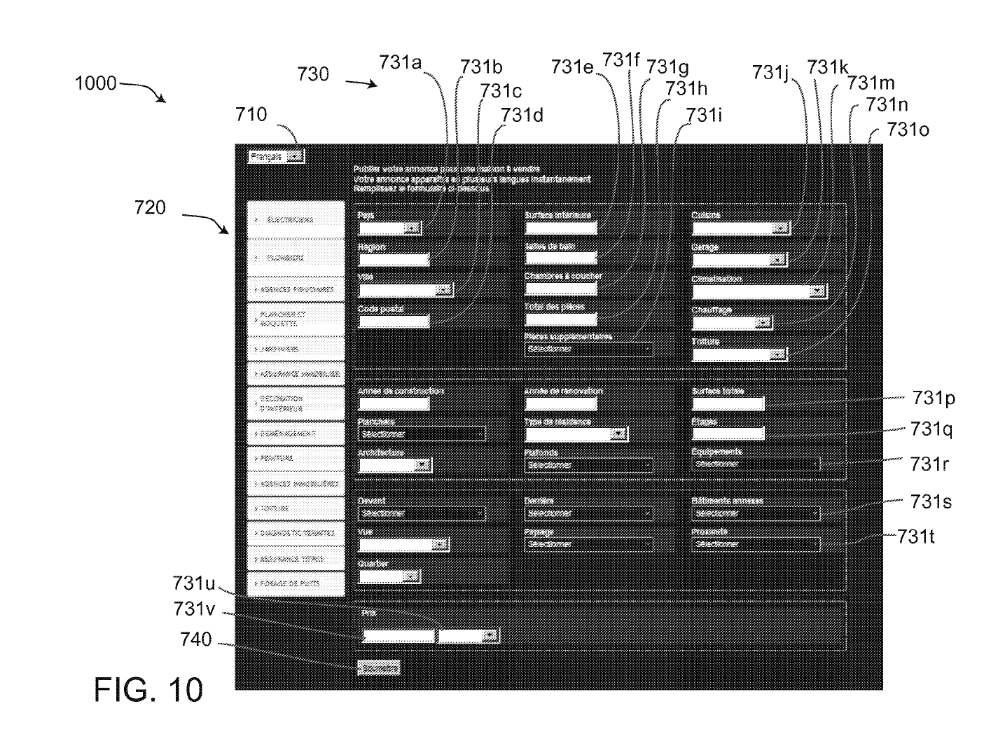

FIG. 10 shows an input form 1000. Input form 1000 is generally similar to input form 700, except that pull-down authoring language menu 710 has French as the selected language, and thus all of the text displayed in input form 1000 is in French. Thus when pull-down menus (for example, fields 731a, 731c, 731j-731o, and 731u), or check boxes (for example, fields 731i, and 731r-731t) are presented on input form 1000, the text appears in French.

The attributes provided in French, or any other authoring language, correspond semantically in each authoring language. Thus, for example, the English-language kitchen attribute represented by the text “fully equipped” is presented as a word, phase, or sentence in any authoring languages to covey the same meaning as the English.

As discussed previously, each attribute, when selected, is stored according to the semantic ID of the selected attribute. Thus the stored attributes for the same item are the same no matter which authoring language is selected. Thus although system 300 may provide one of a plurality of input forms in different languages to collect like information, such as the English form 700 and the equivalent form 1000, the attributes are stored as semantic equivalents. Thus, for example, each attribute may have a unique semantic ID which is the same in each language. Thus, for example, a unique semantic ID for kitchens may be equated with text “fully equipped” in English, with the text “entièrement équipée” in French, with the text “completamente attrezzata” in Italian, etc. Thus no matter which language is used to select what is a fully equipped kitchen, the information is stored as a unique semantic ID. Further semantic data tables are organized by semantic IDs and text in each language, making it easy to generate text is any of the system languages.

In one embodiment, attributes and attribute fields are selected and then linked to specific semantic IDs. Thus, for example, an attribute field may include a plurality of attributes and their corresponding semantic IDs. The attributes and semantic IDs are presented, for example, to device 330 as a pull-down menu in HTML page in a browser. The mark up of the attributes is provided to display 331 as labels in one of the system languages. Each attribute has an associated semantic ID that is provided back to device 310 when the attribute is selected.

### Input Records

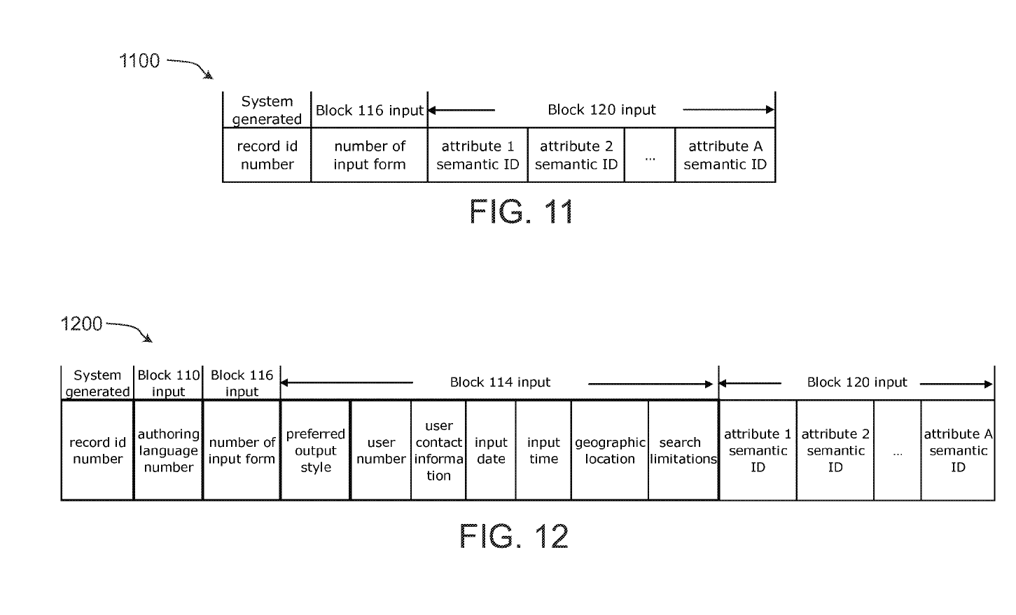

As discussed above, each input to method 200 is stored as an input record. FIG. 11 illustrates the structure of one embodiment of an input record table or database 1100. The data includes a unique input record ID in column 1, a form number in column 2, and the semantic IDs of one or more attributes in the remaining columns. The input record ID is generated in system 300 and stored in block 240 along with the form number as selected in Block 216 and the semantic IDs of the attributes selected in Block 220. In certain embodiments there is only one form present, and the form number data is not present in the database. In certain other embodiments, the number of attribute fields may depend on how the form is filled out. Thus, for example, certain selections may spawn other selections. The input record may this include such information, such as the total number of attributes in the record.

FIG. 12 illustrates the structure of an alternative embodiment input record table or database 1200. Database 1200 is generally similar to database 1100 and may also include one or more of the following data: an ID number of the authoring language selected in Block 210, the form number selected in Block 216, information provided in Block 214, which may include but is not limited to, a preferred output style, a user number, user contact information, input date, input time, geographic location, and search limitations which may limit the results of queries initiated in Block 270. As an example of search limitations, the user inputting data to database 1200 may wish to limit search results to speakers of certain languages. Block 214 allows the user to provide search limiting languages, and the query respects the limitation according to the rendering language of the search.

### Query Forms

Queries may be performed in Block 170 according to information provided to forms in Block 118 in a method and using forms, similar to the input of information as described with reference to Blocks 116, 120, and 130. Specifically, for each input form, there is a corresponding query form in each system language that may be used to query the input records. The query forms have attribute fields that are generally similar to the input form attribute fields. There may be more or less or different attributes in the query form, as needed to formulate a search.

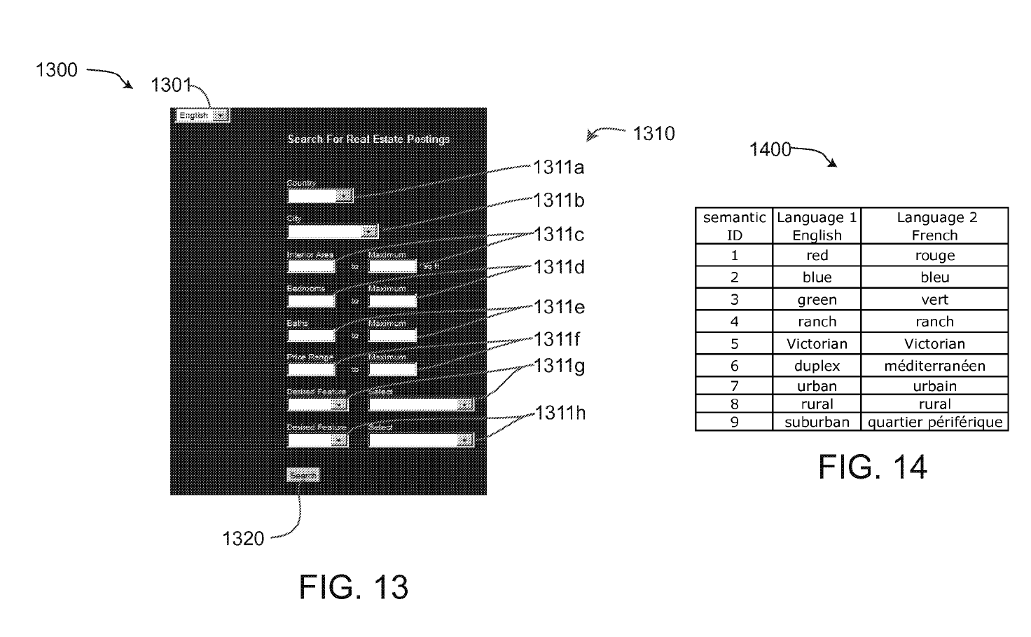

FIG. 13 is one embodiment of a query form 1300 in English. Form 1300 has a pull-down rendering language menu 1301, which is generally similar to menu 710, and which governs the language of form 1300. Form 1300 includes attribute fields 1310 and a submit button 1320. Attribute fields 1310 generally correspond to in put fields 730 are arranged and worded to limit searching of the input records. Thus, for example and without limitation, since menu 710 has selected the language to be English, attribute fields 1310 include the labels “Country” (field 1311a as a pull-down menu), “City” (field 1311b as a pull down menu), a pair of inputs corresponding to a range of “Interior Area” (field 1311c as numeric inputs), a pair of inputs corresponding to a range in the number of “Bedrooms” (field 1311d as numeric inputs), a pair of inputs corresponding to a range in the number of “Bathrooms” (field 1311e as numeric inputs), a pair of inputs corresponding to a range in home “Price” (field 1311f as numeric inputs), and two sets of “Desired Features and Attributes” (field 1311g and 1311h, each having a pull down menu and a check list). If a different system language had been selected in menu 710, then the labels would be provided in the selected language.

With search terms entered into fields 1310, the input record may be searched by pushing search button 1320.

In general, the semantic data for each attribute from query form is determined according to the semantic data tables. In one embodiment, attributes and attribute fields 1310 are presented in the rendering language selected in menu 1301 and are linked to specific semantic IDs. Thus, for example, an attribute field may include a plurality of attributes and their corresponding semantic IDs. The attributes and semantic IDs are presented, for example, to device 330 as a pull-down menu in HTML page in a browser. The mark up of the attributes is provided to display 331 as labels in one of the system languages. Each attribute has an associated semantic ID that is provided back to device 310 when the attribute is selected.

A database search of the stored semantic data returns matching record number IDs, as in FIG. 11 or 12.

In addition, the search may be limited by information with the matching records. For example, the input records may include search limiting data (see FIG. 12, last entry under “Block 114 input). The search will exclude results that do not satisfy these requirements. Thus, for example, the user may limit the search results to certain rendering languages, geographical areas, or other criteria.

In addition, input provided in Block 252 may be used to restrict or modify the search results. Thus for example, input records that are too old may be restricted from output. As another example, the search criteria of Block 260 may be overridden to provide a greater range out matching input records or to ignore certain search criteria.

### Presenting Search Results in Rendering Language

Given the semantic ID and an output language, natural sounding text may be generated in any system language from the semantic data table, the input record, and a knowledge of which form was used to generate the input record. Specifically, syntax and grammar in the rendering language is handled by rules that are specific to that language, which can be programmed to operate on the text strings corresponding to the semantic IDs of the input record. Such rules include, but are not limited to, rules related to gender count and nouns and adjectives agreement, and rules governing word order.

To generate output, system 300 applies the rendering language and style to the input record according to grammar and syntax rule of the rendering language. The following is an example of rules that may be user to generate output. These rules may either be applied by text string manipulation in device 310 or 330, and may occur, for example, by programming in device 310 in a language such as C++ or take place within a suitably programmed marked-up HTML web page on device 330.

In general, method 200 produces output text in the rendering language for each matched record. The following is one method for generating natural sounding output in any language, and for a variety of styles.

The following illustrates how to determine semantic data from the input in an authoring language and how to generate text in a style a rendering language. The example is for illustrative purposes and is not meant to limit the scope of the invention in any way.

Assume that system 300 operates in one of 2 system languages, L: English (L=1) and French (L=2), and can generate output is one of two styles, Sty: simple sentences (Sty=1) or more complex sentences (Sty=2). Further assume that system 300 specializes in home for sale and has one input form and one query form in each system language. In addition, assume that the attributes stored are the color, type, and setting of a home for sale, and that the semantic data table is shown in FIG. 14, which is an example of a semantic data table 1400 to accompany this discussion.

An input form (such as a form similar to that of FIG. 7) provides the attributes in language L, and stores the selections as the ID numbers from the semantic data table 1400 as: the house color as ID_color, the type of house as ID_type, and the setting of the house as ID_setting. Note that the stored semantic IDs are independent of the language used to input the attributes. Thus the record is stored as:(L, ID_color, ID_type, ID_setting). Assume, for the sake of example, that a user provides the input that the house is green ranch house in a urban setting, then the input record is: (L, ID_color, ID_type, ID_setting)=(1, 3, 4, 7).

First, to construct sentences in English, there must be a rule to select the proper indefinite article (“a” or “an”) in English. Writing the text string for an attribute having a semantic ID and language L as A(ID,L). The English language (L=1) syntax rule to select the proper indefinite article, a or an, depending on the first letter of the attribute, for the attribute having semantic data “ID,” may be written in a pseudo-code as:

a_or_an(A(ID,1)= “ an” if the first letter of A(ID,1) is a vowel,

or = “ a” otherwise,

where, the function a_or_an(A(ID,1) compares the first letter of the attribute in English with a list of vowels. The function a_or_an(A(ID,1) then returns the text string (as indicated by the quotation marks) of indefinite article “a” if the first letter of the attribute is a vowel, or “an” if the first letter is not a vowel.

A pseudo-code function for a style 1 sentence in English may be written as the following string manipulation:

string_1_1(ID_color, ID_type, ID_setting) = concatenate(“This
is”, a_or_an(A(ID_type,1), A(ID_type,1), “ style house. It is”,
A(ID_color,1),“ and is located in”, a_or_an(ID_setting,1),
A(ID_setting),” setting.”)

where the function “concatenate” joins text strings together, as indicated. The pseudo-code function for a style 2 sentence in English may be written as;

string_1_2(ID_color, ID_type, ID_setting) = concatenate (“This
is”, a_or_an(A(ID_color,1)”, A(ID_color,1), “-“, A(ID_type,1),“
style house and is located in”, a_or_an(ID_setting,1),
A(ID_setting),” setting.”)

For (ID_color, ID_type, ID_setting)=(3, 4, 7), A(ID_color,1)=A(3,1)=“green;” A(ID_type,1)=A(4,1)=“Mediterranean;” and A(ID_setting,1)=A(7,1)=“urban,” the pseudo code provides the following output for style=1”

string(1,1) = “This is a Mediterranean-style house. It is green
and is located in an urban setting.”

and the following output for style=2:

string(1,2) = “This is a green Mediterranean-style house and is
located in an urban setting.”

Next, assume the following pseudo-code for generating a simple sentence (Sty=1) in French (L=2). First, to construct sentences in French, there must be a rule to select the proper sentence. The French language syntax rule to select the proper indefinite article, “un” or “une,” depending on the gender of the attribute having semantic data “ID,” may be written in a pseudo-code as:

un_or_une(A(ID,2)= “ une” if the last letter of A(ID,1) is an

“e”, or = “ un” otherwise

That is, the indefinite article is “une” for words ending in “e,” or is “un” otherwise. Since there are exceptions to this rule this is a simplification, but will apply for attribute which follow this rule.

A pseudo-code function for a style 1 sentence in French (L=2) may be written as the following string manipulation:

string_2_1(ID_color, ID_type, ID_setting) = concatenate(“C'est
une maison de style”, un_or_une(A(ID_style,2), A(ID_type,2), ″.
Elle est”, A(ID_color,1),“ et située dans un environnement”,
un_or_une(A(ID_setting,1), A(ID_setting))

And for (ID_color, ID_type, ID_setting)=(3,4,7), A(ID_color,2)=A(3,2)=“verte;” A(ID_type,2)=A(4,2)=“méditerranéen;” and A(ID_setting,2)=A(7,2)=“environnement urbain,” the pseudo code provides the following output for style=1 in French (L=2):

“C'est une maison verte de style méditerranéen et située dans un
environnement urbain”.

System 300 may thus accept input in one or more languages, and provide an output in a second language or style on display 331.

In general, system 300 includes programming to permit the generation of text in each language and each style and for each input form. Thus, for example, programming for generating text in each system language for each form and each style is determined before hand, and when a user request the display of an input record in a rendering language, system 300 executes the pre-defined instructions, such as those above illustrating different styles in languages, to generate the appropriate output from the input record. These rules, exist for nouns, verbs, pronouns, prepositions, articles and any word requiring morphological or position change as appropriate. The above example provided above is a simplification, and many other rules may be required as needed, including rules for word order, syntax and grammar, as needed.

### EXAMPLES

Several embodiments of the present invention are described herein, without limitation, as a system and method that provides a platform for the authoring, viewing, and generation of advertisements in different languages. The website allows a user to easily generate an advertisement, instantly, in the language of their choice and post that advertisement in many different languages. In one embodiment, the system accepts input in one language and generates a semantics-based equivalent text in one or more other languages.

Specifically, several embodiments of the present invention provide a system and method 200 for presenting advertisements allows a user to: 1) author an advertisement in an authoring language (according, for example, to the steps of Blocks 210, 216, and 220, and 2) provide equivalent text (according, for example, to the step of Block 250 or 280) in one or more rendering languages. These functions may be facilitated by organizing advertisements according to pre-designed forms with categories and subcategories that encompass products, used or new, services, amateur or professional, and personal advertisements, such as personal relationship advertisements. The advertisements placed on the website may thus be read worldwide and in every available language.

In the following examples, it is assumed that users access the method 100 or 200 through a website on the Internet on a device 330. This is not meant as a limitation, but is merely used to facilitate discussion of the present invention. It is understood that reference to web pages or web sites refer to displays generated on display 331 by system 300 according to method 200.

### Example 1

In one embodiment, the posting and viewing of advertisements on a website is provided. The following is one embodiment of a system 300 that illustrates one such website, and is not meant to limit the scope of the present invention. Display 331 is provided with more or more screens to allow a user to provide system 300 with a: 1) language, 2) city and country of residence; and 3) category or subcategory of the item they are either seeking or offering for sale. In one embodiment, the screens allow the user to provide input by selecting from a limited number of predetermined terms from a database search engine. Alternatively, selections may be made from pull-down menus including the predetermined terms. Thus, for example, display 331 may present a list of language names, each written in its own language such as English, Français, Deutsch, Español, etc. In one embodiment there is a flag corresponding to the language. A language selection may be made by selecting the language button or flag. Alternatively, there may also be an image of the globe of the world slowly rotating. To select a country and language, one may click on an area of the globe, and then drill down to specific countries and languages. As a result of this selection, the language of further text on display 331 is in the user's selected language.

Subsequent website pages may have a “Switch Language” button, which allows the user to change the authoring and display language. Further, the user's selected language is used as the authoring language (for users wishing to place advertisements) and as the rendering language (for users wishing to read advertisements). The following discussion is for an authoring language of English.

Once a language is selected, display 331 may provide a “Welcome Page” in that language. On this page the user may also be provided with an opportunity to bookmark the page or make the page the browser's home page in order not to have to select a language every time. The welcome page may also have words of welcome and the background is a slowly moving printed banner with words and sentences representing ads categories in that particular language. The welcome page may also ask the user “What would you like to do?” and presents two options: PLACE ADS (“input” of Block 212) and READ ADS (“search” of Block 212).

When the READ ADS or the PLACE ADS button is clicked, a series of smaller buttons may appear to aid in the generating of specific advertisements (Blocks 216). Examples of such smaller buttons include, but are not limited to: FOR SALE, FOR RENT, SERVICE OFFERED, WANTED FOR SALE, WANTED RENTAL, WANTED SERVICE , RELATIONSHIPS, and BULLETIN BOARD.

When a user selects one of the smaller buttons, access is provided a new page with an entry blank and a drill down list of categories and subcategories.

The user is then queried to provide information according to an advertisement form (Block 220). Each form includes a specific and detailed description of a product or service. The advertisement placer then completes the form by either typing descriptions in the appropriate fields or by selecting words from pull-down menus. As an example, when searching for a vehicle, the user will be ask to select such criteria as brand name, model, year, and price range as in: 95 BMW 3 series $15,000-$20,000. A more personal text can also be written in a personal opinion field.

The semantic data from this information is then stored, along with an indication that the information is related to an automobile for sale, as in Block 240.

As another example, selecting PLACE ADS, followed by FOR SALE, results in a new page being displayed indicating that the user can either enter a word in the entry blank or drill down through categories and sub-categories.

As an example, if a user enters the word “House” in the entry blank, the next page may be a template entitled “REAL ESTATE: House” with a series of pertinent fields in which to enter information such number of bedrooms, baths, etc. and the possibility of entering pictures. Alternatively, the user could have drilled down through the menus to find the category REAL ESTATE and the sub-category House instead of entering a word in the entry blank. As another alternative, a user may have entered the word Home, or Chalet, or Villa, or other near synonyms with the same effect.

By then selecting a SUBMIT button, the new data is accepted into a database of the system (Block 240), and generates advertisements for this particular house to appear in the READ pages of the site in any language chosen (Block 250). In other words, an ad placed in English can be read in French, Spanish, Chinese, etc. Similarly, a placed in Spanish can be read in English, Chinese, etc.

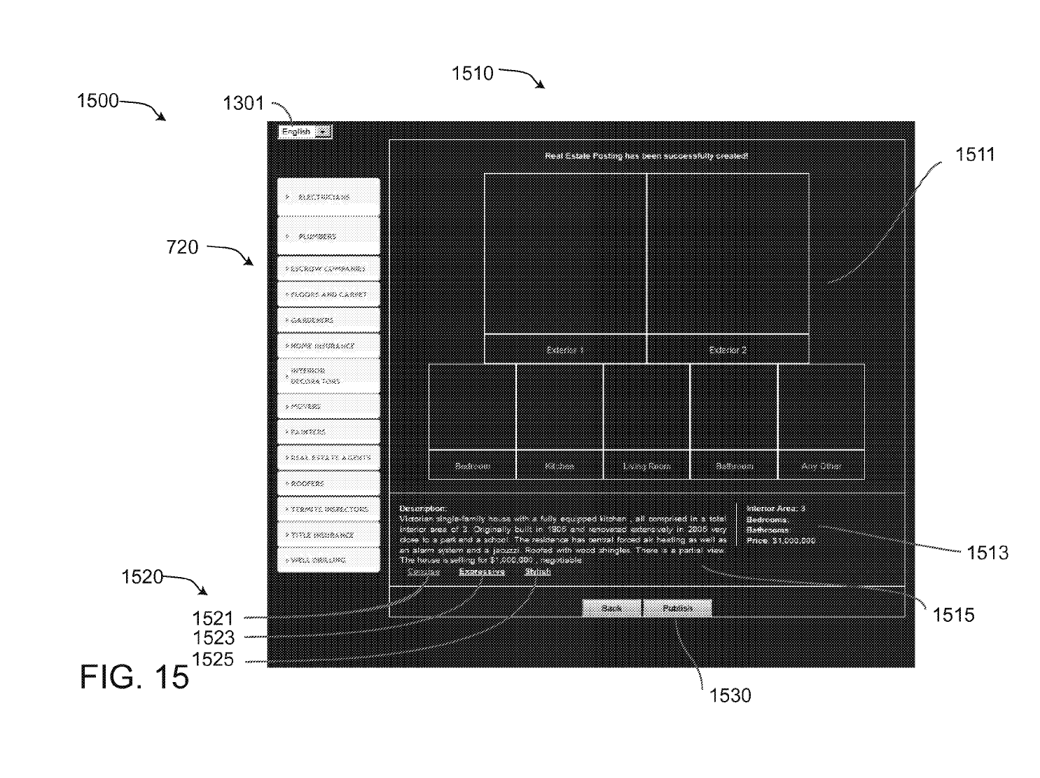

In one embodiment, a writing style may be selected for the advertisement when it is placed. As one example, the generation of text in a rendering language is shown in FIG. 15, which is a preview screen 1500 from a continuation of the example of FIGS. 8 and 9, where an advertisement is being produced. The user provides inputs to fields 730, and then pushes the submit button 740.

Preview screen 1500 includes pull-down rendering language menu 1301 which governs the rendering language of the screen, advertisements 730, house information including photographs, which may be uploaded and place in area 1511, some summary information, such as home size and price, in area 1513, an a descriptive text in area 1515. Preview screen also has writing style selection 1520, which may include a button 1521 to select a “concise” writing style, a button 1523 to select an “expressive” writing style, and a button 1525 to select a “stylish writing style.” In one embodiment, preview screen first appears with “concise” button 1521 selected. In this example, the descriptive text in area 1515 reads, in English:
“Victorian single-family house with a fully equipped kitchen, all comprised in a total interior area of 3. Originally built in 1905 and renovated extensively in 2005 very close to a park and a school. Roofed with wood shingles. The residence has central forced air heating as well as a Jacuzzi and a sauna. There is a partial view. The house is selling for $1,000,000, negotiable.”

As an other example of writing style, the user may choose to publish the advertisement in a more stylish style, and presses button 1525. Preview screen 1500 will regenerate the text in area 1515 to read, in English:
“In a rare opportunity, a much-admired and coveted cozy property is now in the market and it is unlikely it will stay there for long. With a breathtaking a partial view this Victorian single-family house will mesmerize you. The residence was designed and built in 1905 by a well-known architect, who instilled its exterior with sober elegance through subtle details and accents, it is roofed in wood shingles. While a professionally and efficiently designed kitchen space, fully equipped, is a home chefs dream. In 2005 the house was extensively remodeled, restoring the classic materials of its exterior and fitting the interior with modern gadgetry and a state-of-the-art interior climate control computer efficiently manages interior temperature through forced air heating as well as the security and comfort of Jacuzzi and sauna. With three of total interior footprint priced at $1,000,000 with fast, safe and easy access to the nearby park and school in just minutes. By the way, the price is negotiable. Interested? Call your agent now!.”
   Pressing the “Publish” button 1530 causes the selected style to be selected and published in the advertisement.

Posted advertisements are read using a “READ” mode (“search” of Block 212). The website is designed to guide the user to posted items by drilling down through advertisement categories and subcategories. The user selects the category or subcategory of the item they are either seeking or offering for sale. As with the PLACE mode, selection can be done by typing the appropriate words or by selecting the type of item from pull-down menus.

The drill-down search method is similar in both the READ and the PLACE modes. One can either follow a series of drop-down menus or simply type an item in a FAST SEARCH field. In both modes, the search returns templates.

A user who has clicked the READ button is provided with the same choice of entering a word in an entry blank or drilling down to chose a category and subcategory. The entry or the drill down leads to a list of desired attributes for the house sought such as country, region, number of bedrooms, price range, etc. Once the request submitted a list of houses with the desired characteristic appears. The reader can then click on one of the lines to see a full-page ad appear. The full-page ad is a descriptive paragraph and a series of pictures. The user may also be provided with a button that, when selected, allows the user to contact the seller.

In the READ mode the user types the name of the product they are looking for. Before a list of items is returned, the user is asked to specify PRICE RANGE, GEOGRAPHIC RANGE and other specifications needed for the type of item sought. Once the ranges have been specified a list of items appeared that correspond to the specified ranges. The list contains abbreviated descriptions for each listed item. Clicking on the item produces a detailed template with all pertinent information about the item including pictures and sound bites as well as methods to contact the seller. The user may save the item in a private holding area until they are ready to decide between several items and complete the purchase. Once the decision is made, if the item does not need inspection, the user simply clicks on the BUY button and the buying and shipping processes are initiated. The process may include the immediate contact of the seller. After clicking BUY, the template indicates a “Sale Pending”. The buyer is then asked to make an on-line payment. In one embodiment, the money for the purchase is held in escrow and transferred to the seller once the item has been delivered to the buyer. Pick-up, shipping, and delivery are thereby scheduled as the transaction is instantly transmitted to the appropriate shipper (such as FEDEX) for smaller shipments or an approved local, national, or international shipper for larger items.

In the PLACE mode the ad-placer simply types the name of the product or service offered in a search field to retrieve the appropriate ad template. One can also arrive to the appropriate template through a series of pull-down menus allowing the selection of category and subcategories corresponding to the offered item. The retrieved template contains required and optional data fields to be filled. It also includes a description field in which one can type a personal description.

In one embodiment, once the form is complete, clicking on the PLACE button instantaneously publishes the ad in every language available on the web (as in Block 290 of method 200B). One of the fields required in all templates is the city and area code of where the seller is located so that potential buyers who prefer dealing locally can search according to cities and area codes.

### Example 2

The following is one embodiment of a system 300 that illustrates another embodiment, and is not meant to limit the scope of the present invention. Specifically, the following example illustrates the use of form of FIG. 8 which may, for example, be provided on display 331. As discussed subsequently, system 300 and method 100 or 200 form a natural sounding advertisement in the authoring language or in a rendering language. This is an example of a method and system that is useful operating in only one language (that is, the authoring and rendering language are the same).

The steps of Block 280 include a set of rules for constructing advertisements, as described above in the section titled: There are many descriptive nouns and adjectives used in real estate business that arranged as semantic data tables within system 300. So based on the data given, the system uses the corresponding words and expressions to describe the house. Even in this very simple example, the system uses previously created semantic data tables with a few imbedded syntactic and grammatical rules.

For example, Block 230 may assign IDs based on certain ranges of home sizes. If the size entered is between 2,000 and 3,000 sq. ft. or 200 and 300 m², Block 230 may assign a first ID, which Block 280 may assign the English descriptions “very large” or “very spacious.” If the size entered is between 1,800 sq. ft. and 2,000 sq. ft., Block 230 may assign a second ID, which Block 280 may assign the English description “large.” If the size entered is between 1,200 sq. ft. and 1,800 sq. ft., Block 230 may assign a third ID, which Block 280 may assign the English description “comfortable.” If the data is less than 1,000 sq. ft., Block 230 may assign a fourth ID, which Block 280 assigns the English descriptive texts “intimate,” “comfortable,” or “petite.”

Block 280 may include different English words with different levels of descriptiveness or linguistic complexity. Block 280 also includes equivalents in other rendering languages.

In the case of a 2,500 sq. ft. house, for example and without limitation, the number might be 132458, for the meaning of “very large.” This number is an integral part of system 300 and is assigned to that particular descriptive meaning at the time that particular semantic data table was created. One of the rows of the “size” semantic data table may be, for example:

| Semantic ID | English | French | Italian | German |
|---|---|---|---|---|
| 132458 | very large | très grande | grandissima | sehr groβes |

The input is converted to an input record and stored in a database of system 300. In this record, the size field does not contain an ASCII string but the number 132458. In other words, for all the records in the “house table” in the database, the size field will contain a semantic number and not an ASCII number. This is true for all the other fields and for all the other tables in the website database.

Further, when the user clicks the SUBMIT button, the house described in the template is entered in the house template of the website database i.e. in each data field a semantic number is entered. Part of the record may look something like:

| Semantic ID | Size | Construction | Environment | Architecture |
|---|---|---|---|---|
| 56890 | 132458 | 23650 | 20098 | 76210 |

Where the number in each descriptive fields (columns) is a semantic number and a language independent bit of data.

When the record is created, the system creates a textual description of the house by using the semantic values in the record. It does so in every language available in the system. To create the description, the system completes sentences pre-assigned to each form type. Several sentence structures, for instance have been assigned to the house template in the real estate section of the website.

If a very simple sentence like the English text “This is a ______ house” had been assigned to the English house template, the system would write the English text: “This is a very large house” In the description of the classified ad in English. The equivalent French text “Voici une trés grande maison” would be rendered in French, and the equivalent German text “Dies ist ein sehr groβes Haus” would be rendered in German, etc.

Using the semantic IDs and text manipulation, as discussed above, the following different style texts could be generated. Thus for example, the following Style 1 text string could be rendered for reading in English:

“Very large two-story house with 5 bedrooms and 3 baths. Large dinning and living rooms. Modern kitchen. Den. Immense backyard with brick patio. Shade trees and flowers. New swimming pool and changing room. Two-car garage. View of the hills. Private driveway. Flowers and shade trees in vast backyard.”
The following Style 2 text string could be rendered for reading in English:
“A tree-lined private drive way leads to a spectacular two-story home. Enter though the magnificent oak doors and witness the impressive landing opening on a special and comfortable living room adjacent to a dining room that can accommodate a twenty-seat table. Enter the super modern kitchen with the latest in appliance and gadgetry. There are five large bedrooms located on each side of a wide hallway. Two of the bedrooms have their own full bath, while another door opens on a common bathroom, also with bathtub and shower. Step out onto the slate-covered patio large enough for another dining set and admire the hills looming in the distance past the flowerbeds, the elms, and the wide lawn. To the right, a brick path takes you to the spanking new swimming pool. There is a comfortable mini-lodge nearby for you to change in. It includes a sauna and a shower. In the back of the mini-lodge you will find a complete laundry room. This beautiful home will accommodate a large family in great style and comfort.”
And the following Style 3 text string could be rendered for reading in English: “Style is the word! Dizzying the adjective! This home must be seen to be believed. It contained a total of 20 rooms. You might get lost at first but after you find your bearings you may stop out on an amazing terrace worthy of . . . .”

In this embodiment, sentences are created from a pre-entered syntactic frame work. The user chooses a style. In the system, that style corresponds to a series of sentences created in advance to address certain aspects of the description. In the case of a house the sentences address aspects such as size, location, style, amenities, etc. In each style category, these sentences can be modified or replaced from time to time by our native writers to offer variety and freshness. It is important to note that within each writing style option, a multiplicity of sentences can be written by the system based on the entered data. In principle, in the case of a house, since no two houses are absolutely identical, no identical sentences should be created. Descriptions can be modified at will by the user.

As a further example of different equivalents, the following may be produced by system 300 using the same input:

Output in Style 1, in the following English text string:
“This large contemporary house offers five bedrooms and three baths. It has a comfortable wooden deck with a view of the nearby hills. The seventy-foot long swimming pool is two years old. In the garden are inviting shade trees and multicolored flowerbeds . . . ”
Output in Style 2, in the following English text string:
This modern architecture home is vast and comfortable. With five bedrooms and three baths, it also offers a spectacular view from the large wooden deck and a brand new swimming pool . . .

The system can, randomly or not, chose a sentence style to describe the house but with exactly the same data. The writing style is purely an option.

The system can therefore write descriptive sentences in English to describe a particular house. Since the data exists in every language, the system is capable of writing descriptive sentences for the same house in all other languages and will do it automatically.

The French portion of the software may have describe the house in the following French language text stream:

<<Vaste maison contemporaine avec cinq chambres et trois salles de bain. La terrasse en bois offre une vue imprenable sur les collines de la Sainte Beaume. Près du jardin fleuri et ses grands arbres se trouve une piscine neuve de vingt-cinq mètres.>>

It is important to note that the French sentence is NOT a translation of any of the English sentences. It was created by the system using the entered data and the pre-created semantic data tables. From the same data, the system creates sentences in several other languages. All these sentences describe the house in question, and the description is accurate. The data can be entered in any language. In the example above, if the data had been entered in French for instance, the system would have created the same English sentences.

The SUBMIT function invokes the following illustrative routine, as represented by the following pseudo code, wherein “c.a.” means “classified ad”:

New record
Set field [first field]
Go to field [c.a. db/attribute1]
Insert [first field value]
Set field [second field]
Go to field [c.a. db/attribute2]
Insert [second field value]
Set field [third field]
.
.
Set field [last field]
Go to field [c.a. db/attributeLast]
Insert [last field value]
Set field [c.a. db /attribute1]
Lookup [semantic table/row English]¹
Go to [sentence structure db English/attribute1]
Insert [lookup value]
Set field [c.a. db /attribute2]
Lookup [semantic table/row English]
Go to [sentence structuredb English/attribute2]
Insert [lookup value]
Set field [c.a. db /attribute3]
Lookup [semantic table/row English]
Go to [sentence structuredb English/attribute3]
Insert [lookup value]
.
.
Set field [c.a. db /attributeLast]
Lookup [semantic table/row English]
Go to [sentence structuredb English/attributeLast]
Insert [lookup value]
Set field [c.a. db /attribute1]
Lookup [semantic table/row other language]
Go to [sentence structure db other language/attribute1]
Insert [lookup value]
Loop
Last language
End loop

Note that it does not matter which language form a user is working with. System 300 treats all forms as identical because fields are always populated by a number that is language independent, either a measurement number or a semantic number. Each time, system 300 creates text description in every language beginning by English. The English description does not have to be the first one in the routine; a description in any language can be created first. In any case, system 300 creates descriptions in every language in turn.

When the actual c.a. appears with picture and description, one can switch from language to language. The c.a. will appear complete in every language.

### Other Features

The system and method may include item-specific features. To purchase a house, for example, one has to communicate with the seller or agent, visit the premises, and examine pertinent documents. When one purchases a car, one usually needs to see and drive the car before making a decision. For these types of categories, the system only allows the buyer and seller to communicate through secured email. It is up to them to decide whether to move ahead and exchange phone numbers and/or addresses. Of course, a seller could include a phone number as part of the ad if (s)he wishes.

Some other category and sub-category are constituted of items that can be easily sent by mail or courier services, or shipped by a moving company. For these types of items, the system offers two additional services: Guaranteed payment, and Shipping and delivery.

A reader who has just found an item such as a book, a stamp, a coin, a bicycle part that (s)he wants to buy, can either accept the listed price or make an offer. If (s)he accepts the listed price or if the seller accepts the offer, the buyer is asked whether to have the item shipped and the payment guaranteed. The buyer is given a choice of several shipping companies such as FedEx or UPS and is asked to register. The quick registration form collects name address, more of payment, and available time for delivery. Once the request is submitted, the seller immediately receives a similar registration form asking for address, card info for crediting, pick-up time, etc. Once the courier confirms that the item has been delivered, the payment amount is released to the seller. Cost of shipment is automatically added to the bill as well as a small fee for the payment guarantee service.

In the above description, for purposes of explanation, numerous specific details are set forth in order to provide a thorough understanding of various embodiments of the invention. It will be apparent, however, to one skilled in the art, that the methods may be practiced without these specific details.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

Reference throughout this specification to “one embodiment,” “an embodiment,” or “certain embodiments” means that a particular feature, structure or characteristic described in connection with the embodiment is included in at least one embodiment of the present invention. Thus, appearances of the phrases “in one embodiment,” “in an embodiment,” or “in certain embodiments” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

In particular, one skilled in the art will recognize that other programming methods, algorithms, or data structures may be used other than those described above. In particular, the semantic data tables described are merely several examples of the organization of semantic data which facilitates the generation of text, including but not limited to generation in different languages and/or in different writing styles. Thus, for example, the semantic data may exist as a database on a main server, on multiple servers, and/or may be programmed into web pages.

Some portions of the detailed description are presented in terms of methods and symbolic representations of operations on text strings within a computer memory. These descriptions and representations are the means used by those skilled in the data processing arts to most effectively convey the substance of their work to others skilled in the art. A method is here, and generally, conceived to be a self-consistent sequence of steps leading to a desired result.

In addition, the steps indicated in the flowcharts may be combined or re-arranged, and may be executed entirely on one electronic device or on multiple electronic devices. The algorithms and steps presented herein are not inherently related to any particular computer or other apparatus. Various general-purpose systems may be used with programs in accordance with the teachings herein, or it may prove convenient to construct more specialized apparatuses to perform the method steps.

The execution of the methods herein is not described with reference to any particular programming language. It will be appreciated that a variety of programming languages may be used to implement the teachings of the invention as described herein. Furthermore, wherever a component is implemented as software, the component can be implemented as a standalone program, as part of a larger program, as a plurality of separate programs, as a statically or dynamically linked library, as a kernel loadable module, and/or in every and any other way known now or in the future to those of skill in the art of computer programming. Additionally, the present invention is in no way limited to implementation in any specific operating system or environment.

One embodiment of each of the methods described herein is in the form of a computer program that executes on a processing system, e.g., a one or more processors that are part of a system that may be networked together. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code segments embodied in the medium. Any suitable computer readable medium may be used including a magnetic storage device such as a diskette or a hard disk, or an optical storage device such as a CD-ROM.

The invention also includes all of the different combinations embodied herein. Throughout this specification, the term “comprising” shall be synonymous with “including,” “containing,” or “characterized by,” is inclusive or open-ended and does not exclude additional, unrecited elements or method steps. “Comprising” is a term of art which means that the named elements are essential, but other elements may be added and still form a construct within the scope of the statement.

1. A method for operating a computer to generate text in a rendering language, said method comprising:
receiving one or more of a predefined number of inputs in an authoring language, where said inputs include words, phrases, sentences, numbers, or any combination thereof; and
providing one or more grammatically correct sentences in the rendering language to convey the meaning of the inputs.

2. The method of claim 1, where said method further includes
storing an indication of the semantic meaning of the inputs, and
where said providing includes generating said sentences from the semantic meaning of the inputs in the rendering language.

3. The method of claim 1, where said rendering language is the authoring language.

4. The method of claim 1, where said rendering language is a different language than the authoring language.

5. The method of claim 1,
where said providing includes providing the sentences in a writing style selected from a plurality of writing styles.

6. The method of claim 1, where said inputs are provided from a form.

7. The method of claim 6, where said form is a form to collect information for a classified advertisement.

8. The method of claim 6, where said form is a form to collect information related to text containing descriptions, directions, or instructions.

9. The method of claim 1, where said providing provides over the Internet.

10. The method of claim 1, where said providing provides to a portable electronic device.

11. A computer readable medium on which are encoded one or more computer executable code segments that when executed by a processor cause carrying out of a method for operating a computer to generate text, said method comprising:
receiving one or more of a predefined number of inputs in an authoring language, where said inputs include words, phrases, sentences, numbers, or any combination thereof; and
providing one or more grammatically correct sentences in the rendering language to convey the meaning the inputs.

12. The computer readable medium of claim 11, where said method further includes
storing an indication of the meaning of the inputs, and
where said providing includes generating said sentences from the semantic meaning of the inputs in the rendering language.

13. The computer readable medium of claim 11, where said rendering language is the authoring language.

14. The computer readable medium of claim 11, where said rendering language is a different language than the authoring language.

15. The computer readable medium of claim 11,
where said providing includes providing the sentences in a writing style selected from a plurality of writing styles.

16. The computer readable medium of claim 11, where said inputs are provided from a form.

17. The computer readable medium of claim 16, where said form is a form to collect information for a classified advertisement.

18. The computer readable medium of claim 16, where said form is a form to collect information related to text containing descriptions, directions, or instructions.

19. The computer readable medium of claim 11, where said providing provides over the Internet.

20. The computer readable medium of claim 11, where said providing provides to a portable electronic device.

21. A method for operating a computer to provide an output in a rendering language, said method comprising:
retrieving, from computer readable memory, data related to one or more one or more words, phrases, or sentences;
determining text in a rendering language corresponding to the data; and
generating one or more grammatically correct sentences in the rendering language from the determined text.

22. The method of claim 21,
where said data includes semantic data,
where said determining determines text corresponding to said semantic data, and
where said generating generates sentences according to syntax and grammar rules of the rendering language as programmed into a computer.

23. The method of claim 21,
where said rendering language is one of a plurality of languages.

24. The method of claim 21,
where said generating further generates sentences by applying one of a plurality of rendering language writing style rules programmed into a computer,
such that different sentences are generated depending on the applied writing style.

25. The method of claim 21, further providing said one or more grammatically correct sentences over the Internet.

26. The method of claim 21, further providing said one or more grammatically correct sentences over to a portable electronic device.

27. The method of claim 21, where said data is related to items for a classified advertisement.

28. A computer readable medium on which are encoded one or more computer executable code segments that when executed by a processor cause carrying out of a method for operating a computer to provide an output in a rendering language, said method comprising:
retrieving, from computer readable memory, data related to one or more one or more words, phrases, or sentences;
determining text in a rendering language corresponding to the data; and
generating one or more grammatically correct sentences in the rendering language from the determined text.

29. The computer readable medium of claim 28,
where said data includes semantic data,
where said determining determines text corresponding to said semantic data, and
where said generating generates sentences according to syntax and grammar rules of the rendering language as programmed into a computer.

30. The computer readable medium of claim 28, where said rendering language is one of a plurality of languages.

31. The computer readable medium of claim 28, where said generating further generates sentences by applying one of a plurality of rendering language writing style rules programmed into a computer, such that different sentences are generated depending on the applied writing style.

32. The computer readable medium of claim 28, further providing said one or more grammatically correct sentences over the Internet.

33. The computer readable medium of claim 28, further providing said one or more grammatically correct sentences over to a portable electronic device.

34. The computer readable medium of claim 28, where said data is related to items for a classified advertisement.

35. A method for operating a computer to provide text in one of a variety of writing styles, said method comprising:
accepting an input text;
selecting a writing style from one of a plurality of writing styles; and
generating one or more grammatically correct sentences according to the selected writing style, where said sentences convey the meaning of the input text,
such that different sentences are generated depending on the selected writing style.

36. The method of claim 35,
where said input text is stored as semantic data,
where said generating includes determining the text of the semantic data in the rendering language, and
where said generating generates sentences according to syntax rules, grammar rules, and selected writing style rules of the rendering language.

37. The method of claim 36, where the generating is in a rendering language, and where said syntax rules, grammar rules, and selected writing style rules include text string manipulation text in the rendering language.

38. The method of claim 35, where said input text is accepted from a predetermined number of inputs.

39. The method of claim 38, where said input text is accepted from a form.

40. The method of claim 36, where said accepting is in an authoring language, where said generating is in a rendering language, and where said rendering language is said authoring language.

41. The method of claim 40, where said rendering language is a authoring different from said rendering language.

42. The method of claim 35, where said sentences describe an item in a classified advertisement.

43. A computer readable medium on which are encoded one or more computer executable code segments that when executed by a processor cause carrying out of a method for operating a accepting an input text;
selecting a writing style from one of a plurality of writing styles; and
generating one or more grammatically correct sentences according to the selected writing style, where said sentences convey the meaning of the input text,
such that different sentences are generated depending on the selected writing style.

44. The computer readable medium of claim 43,
where said input text is stored as semantic data,
where said generating includes determining the text of the semantic data in the rendering language, and
where said generating generates sentences according to syntax rules, grammar rules, and selected writing style rules of the rendering language.

45. The computer readable medium of claim 44, where the generating is in a rendering language, and where said syntax rules, grammar rules, and selected writing style rules include text string manipulation text in the rendering language.

46. The computer readable medium of claim 43, where said input text is accepted from a predetermined number of inputs.

47. The computer readable medium of claim 46, where said input text is accepted from a form.

48. The computer readable medium of claim 44, where said accepting is in an authoring language, where said generating is in a rendering language, and where said rendering language is said authoring language.

49. The computer readable medium of claim 48, where said rendering language is a authoring different from said rendering language.

50. The computer readable medium of claim 43, where said sentences describe an item in a classified advertisement.

51. A semantic data structure stored in the memory of a computer, where the data structure organizes the meanings of one or more words in a plurality of languages, said data structure comprising:
a plurality of unique semantic identifiers each corresponding to the same or similar meaning in each of the plurality of languages; and
for at least one semantic identifier of the plurality of unique semantic identifiers, data representative of text having the meaning corresponding to said at least one semantic identifier in each language of the plurality of languages,
such that text corresponding to said at least one semantic identifier may be provided in any of the plurality of languages without specific reference to any of the plurality of languages.

52. The semantic data structure of claim 51, wherein a data structure permits the unambiguous association of identically spelt words, phrases, or sentences in one language with different words, phrases, or sentences in a second language.

53. The semantic data structure of claim 51 comprising one database.

54. The semantic data structure of claim 51 comprising a plurality of databases, where at least one database of said plurality of databases includes semantic identifiers having related meanings.

55. The semantic data structure of claim 51, where said meanings are attributes.

56. The semantic data structure of claim 51, further comprising,
for at least one semantic identifier of the plurality of unique semantic identifiers, data representative of one or more semantic identifiers having meanings related to the meanings said at least one semantic identifier,
such that relationships between different semantic identifiers may be established.

57. The semantic data structure of claim 56, where the data is a semantic identifier.

58. The semantic data structure of claim 56, where said one or more semantic identifiers having meanings related to the meanings said at least one semantic identifier are primary to said at least one semantic identifier.

59. The semantic data structure of claim 56, where said one or more semantic identifiers having meanings related to the meanings said at least one semantic identifier are subordinate to said at least one semantic identifier.

60-61. (canceled)
